(19) United States
(12) Patent Application Publication
(10) Pub. No.: US 2026/0056445 A1
(43) Pub. Date: Feb. 26, 2026

(54) Periscope Camera Module

(71) Applicant: NINGBO SUNNY OPOTECH CO., LTD, Yuyao City (CN)

(72) Inventors: HIROSHI OSADA, Yuyao City (CN); Kuan FANG, Yuyao City (CN); Hailing DING, Yuyao City (CN); Yanxia KONG, Yuyao City (CN); Shuying MENG, Yuyao City (CN)

(21) Appl. No.: 19/373,753

(22) Filed: Oct. 30, 2025

Related U.S. Application Data
(63) Continuation of application No. PCT/CN2024/142206, filed on Dec. 25, 2024.

(30) Foreign Application Priority Data
Jul. 5, 2024 (CN) 202410903770.0
Sep. 27, 2024 (CN) 202411364498.X
Sep. 27, 2024 (CN) 202411364507.5
Sep. 27, 2024 (CN) 202411364508.X
Sep. 27, 2024 (CN) 202411364681.X
Sep. 27, 2024 (CN) 202411371401.8
Dec. 25, 2024 (WO) PCT/CN2024/142206

(51) Int. Cl. G03B 13/34; G02B 13/00

(52) U.S. Cl. CPC G03B 13/34; G02B 13/0065

(57) ABSTRACT

A periscope camera module includes an outer frame, a carrier, a pre-pressing actuator assembly, and a support assembly, wherein in a state in which the pre-pressing actuator assembly is not energized, a distance from a frictional contact point between the pre-pressing actuator assembly and a sidewall of the carrier to a support point of a first support port on the sidewall of the carrier is equal to a distance to a support point of a second support part on the sidewall of the carrier. The present invention adopts a side-driving scheme to solve the driving problem caused by an increase in lens specifications of conventional periscope camera modules due to technical iteration.

### CROSS REFERENCE OF RELATED APPLICATION

This is a Continuation application of PCT/CN2024/142206, filed Dec. 25, 2024, which claims priority under 35 U.S.C. 119(a-d) to China application number CN202410903770.0, filed Jul. 5, 2024, China application number CN202411364681.X, filed Sep. 27, 2024, China application number CN202411364507.5, filed Sep. 27, 2024, China application number CN202411364508.X, filed Sep. 27, 2024, and China application number CN202411364498.X, filed Sep. 27, 2024, and China application number CN202411371401.8, filed Sep. 27, 2024, the afore-mentioned patent applications are hereby incorporated by reference in their entireties.

### BACKGROUND OF THE PRESENT INVENTION

### Field of Invention

The present invention relates to a periscope camera module, and more particularly to a periscope camera module with a piezoelectric motor.

### Description of Related Arts

With the improvement of living standards, users' requirements for the camera functions of mobile terminal devices are also constantly increasing, including the demand for telephoto, which requires the ability to clearly capture distant scenes, such as long focusing distance and high focusing accuracy.

In order to achieve the above-mentioned telephoto function, the terminal device usually adopts a periscope camera module, and uses its motor to drive the lens to move to achieve the basic functions of focus and zoom, so as to obtain clear images of distant subjects. However, with the improvement of user demand, the parameter specifications of the periscope lens are constantly required to be iterated, and the corresponding lens size and weight are constantly increasing. Therefore, the thrust and stroke requirements of the motor that drives the lens to move are gradually increasing, and further requirements are also put forward for focusing accuracy. Due to the increase in thrust requirements, the size of the motor itself is gradually increasing, which in turn hinders the realization of lightweight and thinning in the iteration of periscope camera module technology. The existing driving scheme uses an electromagnetic motor, but it has problems such as short stroke, large size, and electromagnetic interference, which can no longer meet the technical requirements of periscope camera modules in future mobile phone cameras.

In addition, when a new type of driving method is needed to be applied to periscope or long-stroke camera modules, such as piezoelectric and other friction contact actuation methods, a new motor architecture is needed to prevent or reduce the risk of the motor causing the lens carrier to deviate or deviate from the photosensitive path, and at the same time avoid the carrier from tilting or flipping due to insufficient support or unbalanced force on its friction contact surface, and avoid the movable carrier carrying the lens from tilting or flipping due to unbalanced force during long-stroke movement, resulting in a gap or direct separation between the motor, reducing the adverse effects on the focusing effect of the camera module, and further improving the stability of the carrier movement. At the same time, the new motor architecture needs to consider the adverse effects on the motion state of the carrier when designing, to avoid the carrier from overturning or getting stuck during movement, causing the periscope camera module to fail to work properly. On the other hand, in order to further meet the development trend of miniaturization of electronic equipment, the periscope camera module needs to limit its own height when designing, so as to improve the compactness and rationality of the overall structure of the periscope camera module.

### SUMMARY OF THE PRESENT INVENTION

An object of the present application is to describe a periscope camera module comprising a driving member, a pre-pressing member and a support member assembled between an outer frame and a carrier. The pre-pressing member applies a pre-pressing force to the driving member along a direction perpendicular to the optical axis, so that the driving member abuts against the carrier and maintains frictional contact, so as to drive the carrier to drive the lens to move. The support member comprises a first supporting part, and the first support part and the second support part are arranged on the upper and lower sides of the driving member along the height direction.

According to another aspect, the present application also describes a periscope camera module comprising an outer frame, a carrier, a pre-pressing actuator assembly and a magnetic attracting assembly, wherein the pre-pressing actuator assembly is assembled on a side wall of the outer frame facing the carrier, and the magnetic attracting assembly is relatively arranged at the bottom of the outer frame and the bottom of the carrier, and the direction of the pre-pressing force and the direction of the magnetic attracting force applied to the carrier are perpendicular to each other and are both perpendicular to the optical axis.

According to another aspect, the present application describes a periscope camera module comprising a pre-pressing actuator assembly which is arranged on a side of an outer frame, a first support part, and a second support part. The first support part is arranged on the same side as the pre-pressing actuator assembly, and the first support part is tightly fitted between the outer frame and the carrier, and the second support part is loosely fitted between the outer frame and the carrier, and the second support part and the pre-pressing actuator assembly are arranged on opposite sides of the outer frame.

Another object of the present application is to describe a periscope camera module comprising a driving member assembled between an outer frame and a carrier, a pre-pressing member and a supporting member. The pre-pressing member applies a pre-pressing force to the driving member along a direction perpendicular to the optical axis, so that the driving member abuts against the carrier and maintains frictional contact, so as to drive the carrier to drive the lens to move. The support member comprises a first support part, and the first supporting part and the second support part are arranged on the upper and lower sides of the driving member along the height direction, wherein the setting position of the pre-pressing actuator assembly is closer to the first support part in the direction perpendicular to the bottom surface of the carrier.

According to one aspect of the present application, a periscope camera module is provided to comprises:
an outer frame;
at least one carrier arranged at an inner side of the outer frame and is capable of moving along an optical axis;
a pre-pressing actuator assembly which is disposed on a side of the carrier and applies a pre-pressing force to the carrier along a direction perpendicular to the optical axis direction, so as to drive the carrier to move along the optical axis direction; and
a support assembly assembled between the outer frame and the carrier, the support assembly comprises a first support part and a second support part, the first support part and the second support part are both arranged on the side of the carrier in contact with the pre-pressing actuator assembly, and the first support part and the second support part are respectively located on upper and lower sides of the pre-pressing actuator assembly;
wherein when the pre-pressing actuator assembly is stationary, the distance from the friction contact point between the pre-pressing actuator assembly and the side wall of the carrier to the support point of the first support part on the side wall of the carrier is equal to the distance to the support point of the second support part on the side wall of the carrier.

According to another aspect of the present application, a periscope camera module is provided to comprises:
an outer frame;
a carrier capable of moving at an inner side of the outer frame along the optical axis direction, wherein the carrier is arranged for carrying at least one lens piece;
a pre-pressing actuator assembly disposed on a side of the carrier and applies a pre-pressing force to the carrier along a direction perpendicular to the optical axis direction, so as to drive the carrier to move along the optical axis direction;
a support assembly assembled between the outer frame and the carrier; and
a magnetic attracting assembly arranged at the bottom of the carrier and comprises a pair of magnetic attracting elements arranged relatively on the outer frame and the carrier and extending in a direction parallel to the optical axis direction. The magnetic attracting assembly generates a magnetic attracting force perpendicular to the pre-pressing direction.

According to another aspect of the present application, a periscope camera module is provided to comprises:
an outer frame;
a carrier capable of moving at an inner side of the outer frame along the optical axis direction, wherein the carrier is arranged for carrying at least one lens piece;
a pre-pressing actuator assembly which is disposed on a side of the carrier and applies a pre-pressing force to the carrier along a direction perpendicular to the optical axis direction, so as to drive the carrier to move along the optical axis direction; and
a support assembly assembled between the outer frame and the carrier, the support assembly comprises a first support part and a second support part;
wherein the first support part and the second support part are respectively arranged on two opposite sides of the carrier, the first support part is arranged on one side of the carrier in contact with the pre-pressing actuator assembly, and the first support part is tightly fitted between the bottom of the outer frame and the bottom of the carrier, and the second support part is arranged on the other side of the carrier not in contact with the pre-pressing actuator assembly and is loosely fitted between the outer frame and the carrier;
wherein the pre-compressing actuation assembly comprises:
a pre-pressing member which is assembled on the side wall of the outer frame;
a driving member which is assembled between the pre-pressing member and the side wall of the carrier;
wherein the pre-pressing member applies a pre-pressing force to the driving member toward the carrier along a direction perpendicular to the side wall of the carrier, so as to maintain frictional contact between the driving member and the side wall of the carrier.

According to another aspect of the present application, a periscope camera module is provided to comprise:
an outer frame;
a carrier capable of moving at an inner side of the outer frame along the optical axis direction, wherein the carrier is arranged for carrying at least one lens piece;
a pre-pressing actuator assembly which is disposed on a side of the carrier and applies a pre-pressing force to the carrier along a direction perpendicular to the optical axis direction, so as to drive the carrier to move along the optical axis direction; and
a support assembly mounted between the outer frame and the carrier, the support assembly comprising at least two support parts, wherein at least one of the support parts is mounted between a side wall of the outer frame having the pre-pressing actuator assembly and a corresponding side wall of the carrier, and at least two of the support parts are arranged opposite to each other at the bottom of the carrier along the optical axis direction;
wherein at least two of the support parts have two end sides along the optical axis direction, and the end side spacing of at least one of the supporting parts assembled between the side wall of the outer frame having the pre-pressing actuator assembly and the corresponding side wall of the carrier is greater than the end side spacing of at least one other support part.

According to another aspect of the present application, a periscope camera module is provided to comprise:
an outer frame;
a carrier capable of moving at an inner side of the outer frame along the optical axis direction, wherein the carrier is arranged for carrying at least one lens piece;
a pre-pressing actuator assembly which is disposed on a side of the carrier and comprises at least one friction head, wherein the pre-pressing actuator assembly applies a pre-pressing force to the carrier along a direction perpendicular to the optical axis direction through the friction head, so as to drive the carrier to move along the optical axis direction; and
a support assembly assembled between the outer frame and the carrier, the support assembly comprising a first support part and a second support part respectively located on two opposite sides of the carrier, the first support part is arranged on a side of the carrier in contact with the pre-compression actuation assembly and being arranged between a bottom of the outer frame and a bottom of the carrier;

Wherein when the pre-pressing actuator assembly is not powered on, the distance from the projection of the second support part on the side wall of the outer frame having the pre-pressing actuator assembly to the friction head is greater than the distance from the projection of the first support part on the side wall of the outer frame having the pre-pressing actuator assembly to the friction head;
wherein the pre-compressing actuator assembly comprises:
a pre-pressing member which is assembled on a side wall of the outer frame;
a driving member which is assembled between the pre-pressing member and the side wall of the carrier and comprises the friction head which is frictionally connected with the side wall of the carrier;
wherein the pre-pressing member applies a pre-pressing force to the driving member toward the carrier along a direction perpendicular to the side wall of the carrier, so as to maintain frictional contact between the driving member and the side wall of the carrier.

### BRIEF DESCRIPTION OF THE DRAWINGS

FIG. 1 is a schematic view illustrating the overall structure of a periscope camera module provided in an embodiment of the present invention (the light deflection module and the fixed lens are not shown).

FIG. 2 is an enlarged view of the structure at point A in FIG. 1.

FIG. 3 is a schematic view illustrating the overall structure of a periscope camera module provided in another embodiment of the present invention (the light deflection module and the fixed lens are not shown).

FIG. 4 is a schematic view illustrating the installation of a pre-pressing actuator assembly with the electric conductive assembly removed provided by another embodiment of the present invention (the light deflection module and the fixed lens are not shown).

FIG. 5 is a top view illustrating the overall structure of the periscope camera module provided in an embodiment of the present invention (the light deflection module and the fixed lens are not shown).

FIG. 6 is a cross-sectional view along line A-A in FIG. 5.

FIG. 7 is an enlarged view of the structure at area B in FIG. 6.

FIG. 8 is an enlarged view of the structure at area C in FIG. 6.

FIG. 9 is an enlarged view of the structure at area D in FIG. 6.

FIG. 10 is an enlarged view of the structure at area E in FIG. 6.

FIG. 11 is a schematic view illustrating the overall structure of a periscope camera module with the outer frame removed according to an embodiment of the present invention.

FIG. 12 is a bottom view illustrating the overall structure of the periscope camera module with the outer frame removed provided by an embodiment of the present invention.

FIG. 13 is a schematic view illustrating the structure of a carrier and a support assembly provided in an embodiment of the present invention.

FIG. 14 is a schematic view illustrating the overall structure of a periscope camera module with the outer frame removed provided by another embodiment of the present invention.

FIG. 15 is a bottom view illustrating the overall structure of a periscope camera module with the outer frame removed provided by another embodiment of the present invention.

FIG. 16 is a perspective view illustrating the overall structure of a periscope camera module with the outer frame removed provided by another embodiment of the present invention.

FIG. 17 is another perspective view illustrating the overall structure of a periscope camera module with the outer frame removed provided by another embodiment of the present invention.

FIG. 18 is a schematic view illustrating a planar resilient piece structure provided in an embodiment of the present invention.

FIG. 19 is a schematic view illustrating a resilient piece provided in another embodiment of the present invention.

FIG. 20 is a schematic view illustrating a resilient piece provided in yet another embodiment of the present invention.

FIG. 21 is a top view illustrating the overall structure of a periscope camera module provided in another embodiment of the present invention (the light deflection module and the fixed lens are not shown).

FIG. 22 is a cross-sectional view along line F-F in FIG. 21.

FIG. 23 is a cross-sectional view along line G-G in FIG. 21.

FIG. 24 is an enlarged view of the structure at area H in FIG. 22.

FIG. 25 is an enlarged view of the structure at area I in FIG. 22.

FIG. 26 is an enlarged view of the structure at area J in FIG. 22.

FIG. 27 is an enlarged view of the structure at area K in FIG. 23.

FIG. 28 is a schematic view illustrating a yoke structure provided in an embodiment of the present invention.

FIG. 29 is a bottom view illustrating the overall structure of the periscope camera module with the outer frame removed provided by an embodiment of the present invention.

FIG. 30 is a schematic view illustrating the structure of a carrier and a support assembly provided in an embodiment of the present invention.

FIG. 31 is a stereoscopic assembly view of the pre-pressinged actuator assembly, the yoke and the metal part in the periscope camera module with the outer frame removed provided by another embodiment of the present invention.

FIG. 32 is an exploded view of the assembly of the pre-pressinged actuator assembly, the yoke and the metal part in the periscope camera module with the outer frame removed provided in another embodiment of the present invention.

FIG. 33 is a schematic view illustrating the assembly of the pre-pressinged actuator assembly, the yoke and the metal part in the periscope camera module with the outer frame removed provided in another embodiment of the present invention.

FIG. 34 is a schematic view illustrating the structure of a carrier and a magnetic attracting magnet provided in another embodiment of the present invention.

FIG. 35 is a schematic view illustrating the structure of a carrier and a magnetic attracting magnet provided in another embodiment of the present invention.

FIG. 36 is a schematic view illustrating the installation of a pre-pressinged actuator assembly with the electric conductive assembly removed provided by another embodiment of the present invention (the light deflection module and the fixed lens are not shown).

FIG. 37 is a schematic view illustrating the overall structure of the periscope camera module with the outer frame removed provided by an embodiment of the present invention.

In the drawings: 100, outer frame; 110, first side wall; 111, driver installation area; 112, first abutting surface; 120, second side wall; 121, second abutting surface; 200, carrier; 210, lens carrier; 211, first carrier side wall; 2111, third abutting surface; 212, second carrier side wall; 2121, fourth abutting surface; 213, friction contact position; 214, friction plate; 215, damping member; 216, sensing magnet groove; 300, pre-pressing actuator assembly; 310, driving member; 311, friction head; 312, piezoelectric vibrator; 320, pre-pressing member; 321, resilient piece; 3211, fixing part; 32111, first fixed end; 32112, second fixed end; 32113, third fixed end; 32114, first fixing portion; 32115, second fixing portion; 3212, elastic part; 32121, first elastic portion; 32122, second elastic portion; 32123, hollow structure; 3213, bending part; 32131, first bending portion; 32132, second bending portion; 322, clamping piece; 323, buffer member; 324, structural member; 400, support assembly; 410, first support part; 411, first ball; 412, second ball; 420, second support part; 421, third ball; 422, fourth ball; 423, top guide rod; 430, third support part; 431, fifth ball; 432, sixth ball; 440, L-shaped guide groove; 450, U-shaped guide Groove; 460, inclined side wall guide groove; 470, pressing accessory; 480, metal part; 500, optical assembly; 510, light deflection module; 520, optical lens piece; 600, magnetic attracting assembly; 610, magnetic attracting magnet; 620, yoke; 621, planar section; 622, bending section; 6211, projection area; 6212, connection area; 623, edge section; 700, electric conductive assembly; 800, position sensing assembly; 810, position sensing element; 820, position sensing magnet.

### DETAILED DESCRIPTION OF THE PREFERRED EMBODIMENT

Below, the present application is further described in conjunction with specific implementation methods. It should be noted that, under the premise of no conflict, the various embodiments or technical features described below can be arbitrarily combined to form new embodiments.

In the description of the present application, it should be noted that directional words, such as the terms “center”, “lateral”, “longitudinal”, “length”, “width”, “thickness”, “up”, “down”, “front”, “back”, “left”, “right”, “vertical”, “horizontal”, “top”, “bottom”, “inside”, “outside”, “clockwise”, “counterclockwise”, etc., indicating directions and positional relationships are based on the directions or positional relationships shown in the accompanying drawings, and are only for the convenience of narrating the present application and simplifying the description, and do not indicate or imply that the device or element referred to must have a specific direction, be constructed and operated in a specific direction, and cannot be understood as limiting the specific scope of protection of the present application.

It should be noted that the terms “first”, “second”, etc. in the description and claims of the present application are used to distinguish similar objects, and are not necessarily used to describe a specific order or sequence.

The terms “include” and “have” and any variations thereof in the specification and claims of this application are intended to cover non-exclusive inclusions. For example, a process, method, system, product or apparatus comprising a series of steps or units is not necessarily limited to those steps or units explicitly listed, but may comprise other steps or units not explicitly listed or inherent to these processes, methods, products or apparatuses.

The following will clearly and completely describe the concept, specific structure and technical effects of the present invention in combination with the embodiments and drawings, so as to fully understand the purpose, characteristics and effects of the present invention. Obviously, the described embodiments are only part of the embodiments of the present invention, not all of them. Based on the embodiments of the present invention, other embodiments obtained by technicians in this field without creative work are all within the scope of protection of the present invention. In addition, all the connection/connection relationships involved in the patent do not refer to the direct connection of components, but refer to the formation of a better connection structure by adding or reducing connection accessories according to the specific implementation situation. The various technical features in the invention can be combined interchangeably without conflicting with each other.

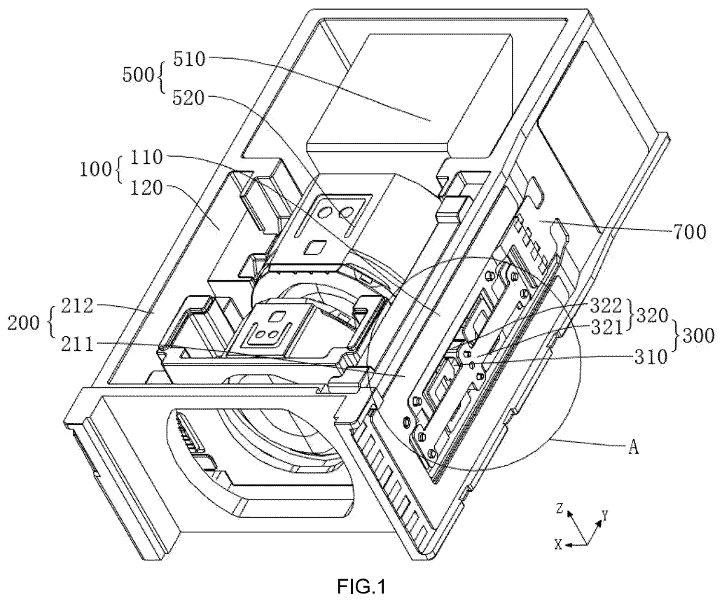

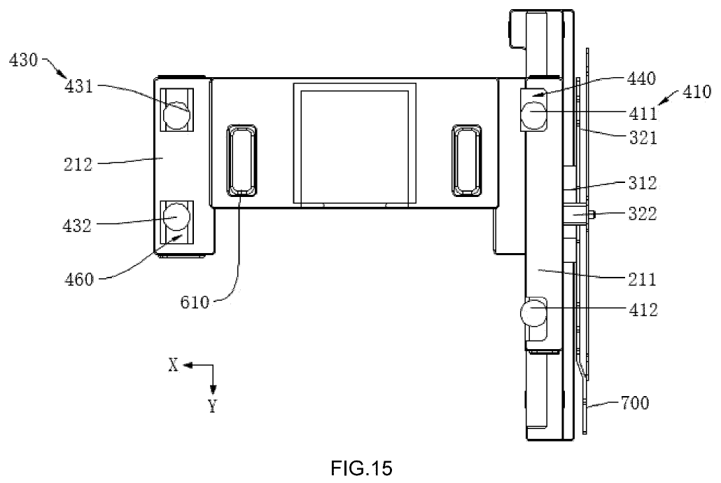

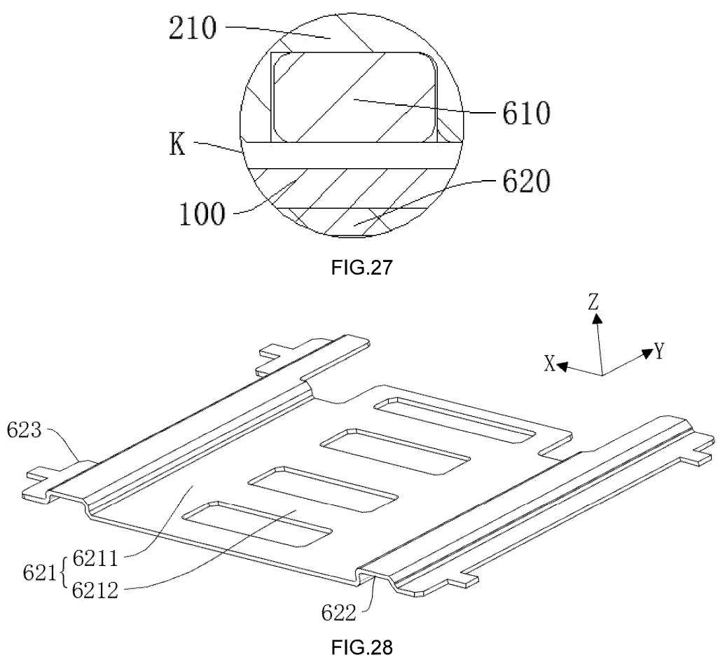

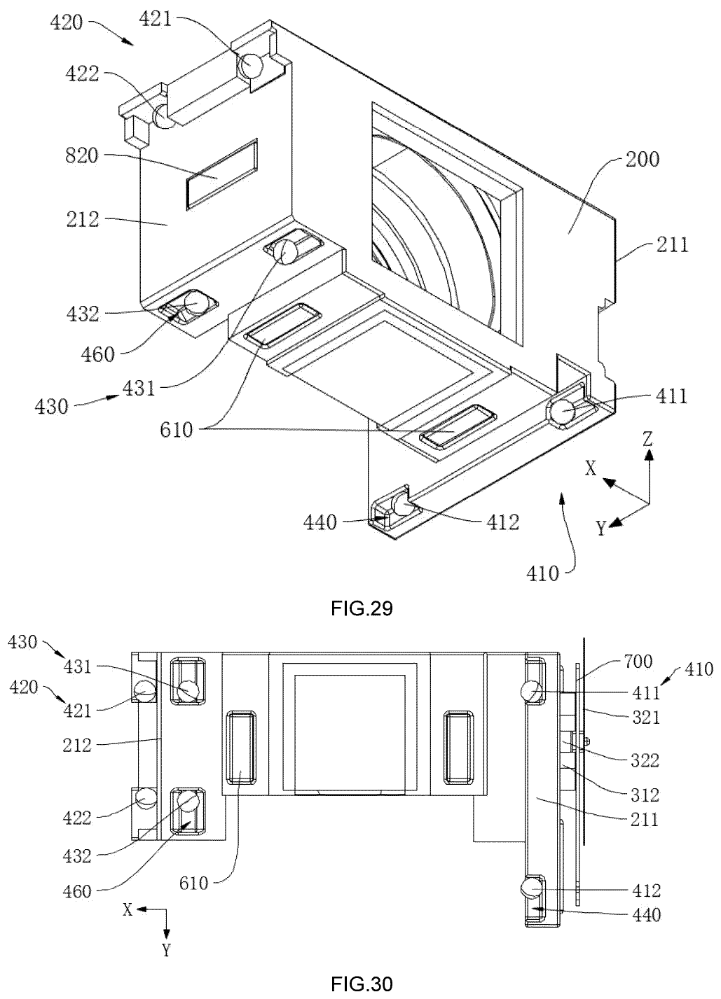

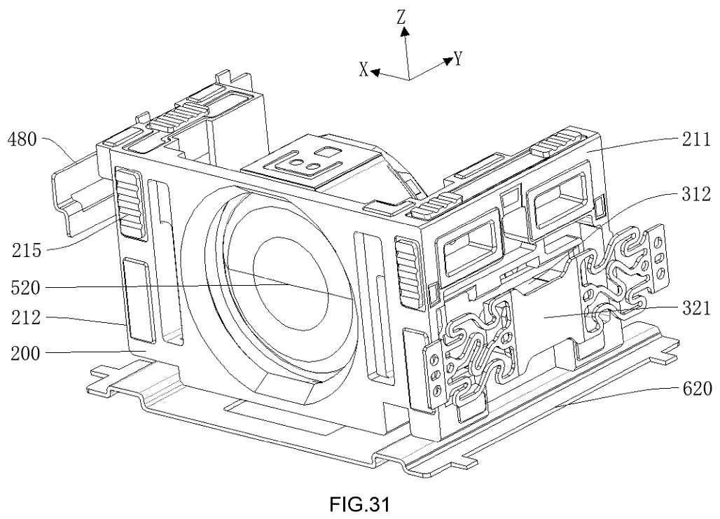

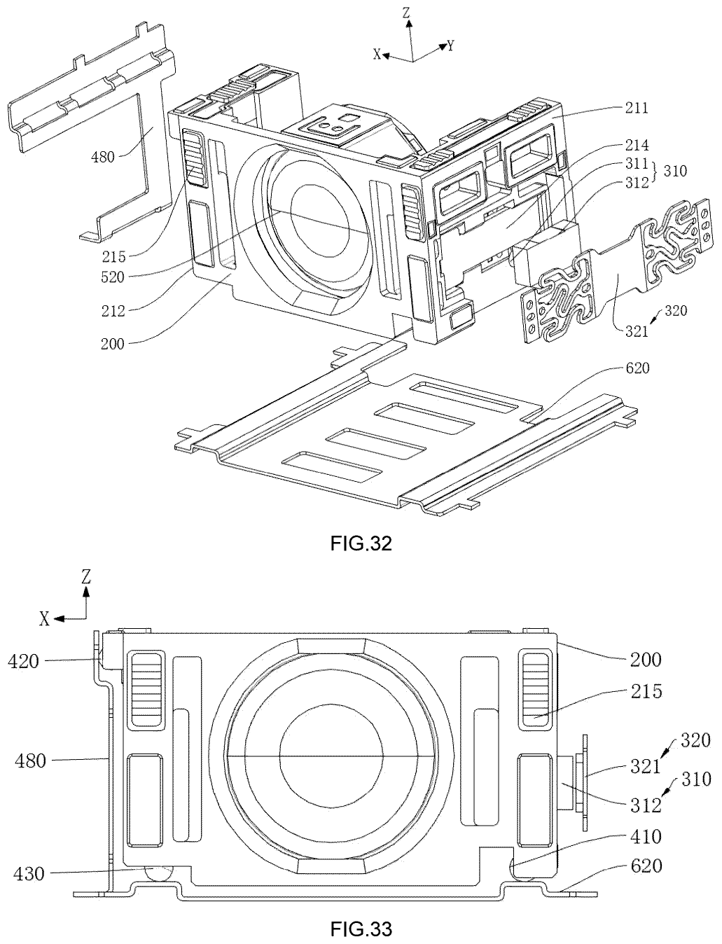

As shown in FIGS. 1 to 37, a periscope camera module according to an embodiment of the present application is illustrated, the periscope camera module comprises an outer frame 100, a carrier 200, a pre-pressing actuator assembly 300, and a support assembly 400. The outer frame 100 has at least one light inlet and one light outlet, and the light inlet and the light outlet are used to allow light to enter and exit. The carrier 200 moves along an axial direction in the outer frame 100, and the axial direction is consistent with or parallel to the optical axis direction of the optical element (such as a camera lens or a lens piece) carried by the carrier 200. Referring to FIGS. 1, 2, 3, 4 and 36, the outer frame 100 comprises a bottom entity extending along the optical axis and two side entities extending vertically upward from both sides of the bottom entity. The pre-pressing actuator assembly 300 is assembled on one side entity of the outer frame 100. The pre-pressing actuator assembly 300 abuts against and drives a side of the carrier 200, so as to drive the carrier 200 to move along the optical axis, thereby realizing the zoom and/or focus function of the periscope camera module. The support assembly 400 is correspondingly assembled between the opposite surfaces of the outer frame 100 and the carrier 200, providing a more stable support for the carrier 200 to always move along the optical axis. The support assembly 400 can also reduce the risk of deviation, tilt or even jamming that may occur during the movement of the carrier 200.

The periscope camera module described in the embodiment of the present application further comprises an optical assembly 500 which comprises a fixed optical component and a movable optical component arranged along the light propagation path, the fixed optical component and the movable optical component respectively comprise at least one optical lens piece 520, the fixed optical component is arranged on the outer frame 100, and the movable optical component is arranged on the carrier 200. In some embodiments, as shown in FIGS. 1, 2, 3, 4 and 36, light enters through the opening on the light entry side of the outer frame 100, passes through the fixed optical component and the movable optical component in sequence along the optical axis, and then passes out from the opening on the light exit side of the outer frame 100, then the light entry side of the outer frame 100 is the light inlet side, and the light exit side of the outer frame 100 is the light outlet side.

In addition, the periscope camera module further comprises a photosensitive module (not shown in the figure) and a light deflection module 510. The light deflection module 510 changes the direction of the incident light and makes the deflected light pass through the fixed optical component and the movable optical component in sequence, and finally converges to the photosensitive module, which receives the light and forms an image.

In a specific example of the present application, the light deflection module 510 is installed on the light entry side of the outer frame 100, and the photosensitive module is assembled on the light exit side of the outer frame 100.

In the periscope camera module provided by the related technology, the periscope camera module comprises the outer frame 100, the carrier 200, a driving assembly, a light deflection module 510, a lens module (optical assembly 500) and a photosensitive module. The carrier 200 moves along the optical axis in the outer frame 100, the optical assembly 500 is arranged on the light entry side of the outer frame 100 and the carrier 200 which are located along the optical axis, and the photosensitive module is located on the light exit side of the outer frame 100, that is, the outer frame 100, the carrier 200, the light deflection module 510, the lens module (optical assembly 500) and the photosensitive module are all located in the horizontal space where the optical axis is located. In the case of the above-mentioned structure, if the driving assembly is arranged on the optical axis in the length direction, the length of the periscope camera module will be greatly increased. At the same time, the thrust required for the driving assembly is relatively large, which will make it difficult to reduce the size of the driving assembly, thereby increasing the overall size of the periscope camera module; if the driving assembly is arranged on the top or bottom side of the carrier 200 in the height direction, the height of the periscope camera module will be increased, which is not conducive to improving the structural compactness of the periscope camera module and the electronic device.

It should be understood that the periscope camera module is arranged in the electronic device in a “lying” fitting manner. For example, the light deflection module 510, the lens module (i.e., the optical assembly 500) and the photosensitive module in the periscope camera module are arranged along the length direction or the width direction of the electronic device, respectively, so as to avoid increasing the height (i.e., thickness) of the electronic device due to the longer length of the periscope camera module. In other words, the height (i.e., thickness) of the electronic device is limited by the height of the periscope camera module, and has nothing to do with the length and width of the periscope camera module.

The photosensitive module comprises a photosensitive assembly and an optical filter assembly. The optical filter assembly is arranged between the optical assembly 500 and the photosensitive assembly and is located on the photosensitive path of the photosensitive assembly, and is used to filter the light before entering the photosensitive assembly. The photosensitive assembly is arranged on the light exit side of the outer frame 100. The optical filter assembly comprises a filter element and a filter element bracket. The filter element bracket is located between the filter element and the light exit side of the outer frame 100 or between the filter element and the carrier 200, so that the filter element is located on the photosensitive path. Specifically, the photosensitive assembly is implemented as a circuit board and a photosensitive chip and electronic components mounted on the circuit board.

As users' demands for the camera function of the module are getting higher and higher, the volume of the drive motor is also increasing due to the long stroke and high thrust. At the same time, with the development of lightweight electronic equipment, the height of the periscope camera module will still become an obstacle to reducing the height of electronic equipment. Therefore, in this application, the structure of the periscope camera module is designed to reduce the volume of the drive motor and avoid the increase in the height of the periscope camera module, thereby meeting the development trend of miniaturization of electronic equipment. It is necessary to develop a motor device with high thrust and small size and a corresponding new periscope camera module drive architecture. Among them, the piezoelectric motor is a cutting-edge but potential camera motor solution with the advantages of high thrust, small size, low power consumption, fast response and no magnetic interference. The corresponding new periscope camera module drive architecture has a smaller total height.

The present application proposes a new driving architecture of a periscope camera module comprising the outer frame 100, the carrier 200, the support assembly 400 and the pre-pressing actuator assembly 300. The pre-pressing actuator assembly 300 applies pre-pressing to the carrier 200 from a side wall of the carrier 200 in a direction perpendicular to the optical axis, so that the carrier 200 maintains frictional contact with the pre-pressing actuator assembly 300 and the carrier 200 is driven to move along the optical axis, that is, the carrier 200 is driven to move by frictional contact, thereby reducing the volume of the driving structure required for the movement of the carrier 200.

It should be understood that the pre-pressing actuator assembly 300 comprises a driving member 310 and a pre-pressing member 320, and further comprises an electric conductive assembly 700 for electrically conducting the pre-pressing actuator assembly 300. The driving member 310, the pre-pressing member 320 and the electric conductive assembly 700 are sequentially arranged on one side of the carrier 200. Therefore, a certain space needs to be reserved in the periscope camera module to arrange the various components of the pre-pressing actuator assembly 300. If the pre-pressing actuator assembly 300 is arranged on the bottom and top sides of the carrier 200, the height of the periscope camera module will increase, thereby increasing the height of the electronic device.

In order to avoid the above situation, in the present application, the pre-pressing actuator assembly 300 is arranged on the side of the carrier 200, which can not only make full use of the space on the side of the periscope camera module, ensure the compactness and rationality of the overall structure of the periscope camera module, but also avoid increasing the height of the periscope camera module.

Furthermore, in order to ensure the stability of the carrier 200 in the periscope camera module and prevent the carrier 200 from falling off when the device is moved or flipped, the periscope camera module of the present application further comprises a magnetic attracting assembly 600 which is relatively arranged on the outer frame 100 and the carrier 200 and extended in a direction parallel to the optical axis, and applies a magnetic suction force perpendicular to the optical axis direction and the pre-pressing direction to the carrier 200. The magnetic attracting assembly 600 comprises a magnetic attracting magnet 610 and a yoke 620. The magnetic attracting magnet 610 is arranged at one of the carrier 200 and the outer frame 100, and the yoke 620 is arranged at the other of the carrier 200 and the outer frame 100. A magnetic attracting force is generated between the magnetic attracting magnet 610 and the yoke 620 to ensure that the carrier 200 will not produce a large deviation during long-stroke movement, thereby keeping the carrier 200 stably set in the periscope camera module and improving the reliability of the periscope camera module.

In some embodiments of the present application, the direction of the magnetic attracting force of the magnetic attracting assembly 600 on the carrier 200 is perpendicular to the direction of the pre-pressing of the pre-pressing actuator assembly 300 on the carrier 200, so as to avoid the superposition of pre-pressing and magnetic attracting force to generate excessive driving burden on the pre-pressing actuator assembly 300.

If the pre-pressing direction is parallel to the magnetic attracting direction, when the pre-pressing direction is the same as the magnetic attracting direction, that is, the magnetic attracting direction is preferably vertically downward (to ensure that the carrier 200 is stably arranged in the periscope camera module), the pre-pressing direction is also vertically downward. In this case, the pre-pressing actuator assembly 300 needs to be arranged on the upper side of the carrier 200, which will increase the height of the periscope camera module. Moreover, the pre-pressing and the magnetic attracting force are superimposed on each other, so that a greater driving force is required to drive the carrier 200 to move, which will require a larger voltage to be provided to the driving member 300, thereby increasing the volume and size of the driving member 310; when the direction of the pre-pressing is opposite to the direction of the magnetic attracting force, that is, the direction of the magnetic attracting force is vertically downward and the direction of the pre-pressing is vertically upward, in this case, the pre-pressing actuator assembly 300 needs to be arranged on the bottom side of the carrier 200, which will cause the height of the periscope camera module to increase. At the same time, the magnetic attracting force and the pre-pressing in opposite directions will offset each other partially or completely, thereby affecting the driving effect of the pre-pressing actuator assembly 300 and the stability of the carrier 200 on the outer frame 100.

In addition, the superposition of pre-pressing and magnetic attracting will cause serious wear between the support assembly 400 (such as ball bearings) and the carrier 200 or between the support assembly 400 (such as ball bearings) and the outer frame 100, and pits will be generated on the surface of the support assembly 400 (such as ball bearings), the surface of the carrier 200 or the surface of the outer frame 100, affecting the driving effect, or debris or damage will be generated due to friction, increasing the risk of the support assembly 400 (such as ball bearings) getting stuck during operation, affecting the operating effect.

Therefore, the pre-pressing and magnetic attracting forces with different directions of action and perpendicular to each other can avoid mutual interference between the pre-pressing actuator assembly 300 and the magnetic attracting assembly 600, so as to maximize the effect of the pre-pressing and magnetic attracting forces, that is, the pre-pressing actuator assembly 300 acts on the side of the carrier 200 to provide a driving force for the movement of the carrier 200 along the optical axis, and the magnetic attracting assembly 600 is arranged at the bottom so that the carrier 200 can remain stable during long-stroke movement. In other words, the driving effect of the pre-pressing actuator assembly 300 and the stability of the carrier 200 on the outer frame 100 are maximized, thereby improving the stability and reliability of the periscope camera module. Moreover, when it is necessary to adjust the pre-pressing force or the value of the pre-pressing force, the directions of action of the pre-pressing and the magnetic attracting forces are perpendicular to each other, so that the pre-pressing actuator assembly 300 located at the side and the magnetic attracting assembly 600 located at the bottom are easier to adjust, so as to reduce or avoid the adverse effects of the direction of the force on the adjustment of the degree of action, and reduce interference factors in the adjustment.

Furthermore, the direction of the magnetic attracting force of the magnetic attracting assembly 600 on the carrier 200 and the direction of the pre-pressing of the pre-pressing actuator assembly 300 on the carrier 200 are both perpendicular to the optical axis direction, so as to further avoid the interference of the magnetic attracting force and the pre-pressing on the driving force, thereby separating the force on the carrier 200 into three mutually perpendicular and non-interfering forces, namely, the pre-pressing in the width direction, the magnetic attracting force in the height direction, and the driving force in the length direction (optical axis direction). The magnetic attracting assembly 600 is arranged at the bottom of the carrier 200, that is, the magnetic attracting force generated between the magnetic attracting magnet 610 and the yoke 620 is along the height direction of the periscope camera module (that is, the height direction of the outer frame 100), and the pre-pressing generated by the pre-pressing member 320 is along the width direction of the periscope camera module (that is, the width direction of the outer frame 100).

In some optional embodiments, a magnetic attracting force is generated between a magnetic attracting component (such as the magnetic attracting magnet 610) located on the carrier 200 and the yoke 620 located on the outer frame 100. The magnetic attracting component and the yoke 620 form a magnetic attracting structure located on the bottom side of the carrier 200. The magnetic attracting structure can generate a magnetic attracting force to ensure that the carrier 200 does not produce a large displacement during long-stroke movement. At the same time, the magnetic attracting structure located on the bottom side can avoid the superposition of pre-pressing and magnetic attracting force, which will not produce too much driving burden on the pre-pressing actuator assembly 300.

In some embodiments of the present application, the direction of the magnetic attracting force of the magnetic attracting assembly 600 on the carrier 200 is perpendicular to the direction of the pre-pressing of the pre-pressing actuator assembly 300 on the carrier 200, so as to avoid the superposition of pre-pressing and magnetic attracting force to generate excessive driving burden on the pre-pressing actuator assembly 300.

In a specific example of the present application, the outer frame 100 is extended from the left and right side edges of the light entry side parallel to the optical axis direction to form two side walls, at least one pre-pressing actuator assembly 300 is assembled on one of the side walls of the outer frame 100, the side wall of the outer frame 100 is set as the first side wall 110 of the outer frame 100, and the other side wall opposite to the first side wall 110 of the outer frame 100 is set as the second side wall 120 of the outer frame 100. Similarly, the two side walls of the carrier 200 opposite to the first side wall 110 and the second side wall 120 of the outer frame 100 are correspondingly set as the first carrier side wall 211 and the second carrier side wall 212 of the carrier 200.

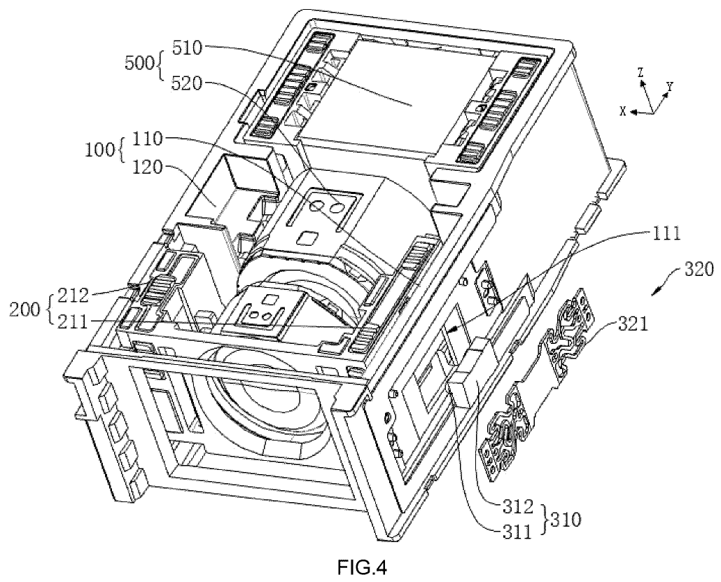

As shown in FIG. 4, the outer frame 100 has a driver installation area 111 for assembling the pre-pressing actuator assembly 300 on the first side wall 110. In some specific embodiments, the driver installation area 111 of the first side wall 110 of the outer frame 100 can be implemented as a through hole located on the first side wall 110 of the outer frame 100, which is used to assist the installation of the pre-pressing actuator assembly 300. The shape of the through hole on the first side wall 110 of the outer frame 100 corresponds to the outer contour shape of the driving member 310 of the pre-pressing actuator assembly 300, and the size of the through hole is slightly larger than the outer contour shape size of the driving member 310.

More specifically, a mounting groove with a diameter slightly larger than that of the through hole is provided on the outer surface of the first side wall 110 of the outer frame 100 along the outer periphery of the through hole for locating the installation position of the pre-pressing actuator assembly 300 from the outside so as to install the pre-pressing actuator assembly 300.

In a specific example of the present application, the carrier 200 moves within the space of the outer frame 100 and carries the mobile optical assembly, wherein the mobile optical assembly comprises at least one optical lens, and the movement of the carrier 200 drives the mobile optical assembly to move, so as to realize the focus and/or zoom function of the periscope camera module. In some optional embodiments, the mobile optical assembly comprises two optical lenses, and the number of the carriers 200 corresponds to the number of the optical lenses. For example, the carrier 200 is implemented as two mobile carriers, and the two mobile carriers respectively drive two optical lenses 520 to move along the optical axis direction to realize the zoom and focus functions.

Specifically, the carrier 200 is implemented as a lens carrier 210 having a first carrier side wall 211 and a second carrier side wall 212. The lens carrier 210 is implemented as a first mobile carrier and a second mobile carrier respectively carrying an optical lens piece 520. The first mobile carrier and the second mobile carrier both have a first carrier side wall 211 and a second carrier side wall 212. The first mobile carrier and the second mobile carrier can be implemented as a split structure or a parent-child structure. When implemented as a split structure, the first mobile carrier and the second mobile carrier can be driven to move along the optical axis direction respectively to achieve the functions of zooming and focusing; when implemented as a parent-child structure, the second mobile carrier can be movably arranged on the first mobile carrier, and the first mobile carrier drives the second mobile carrier to move along the optical axis direction to achieve the functions of zooming and focusing.

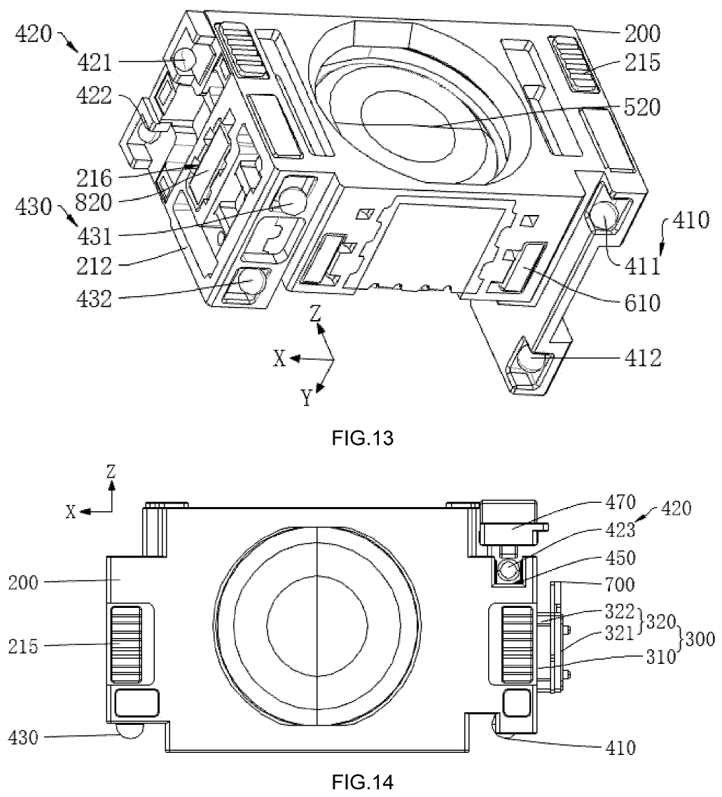

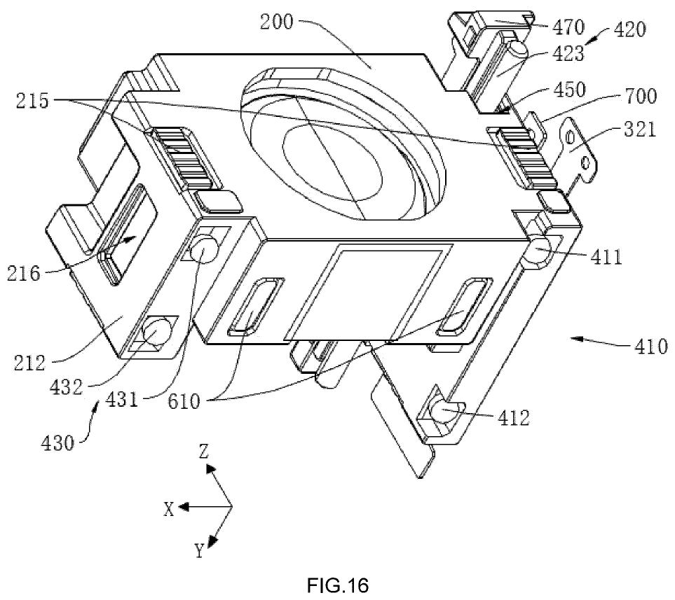

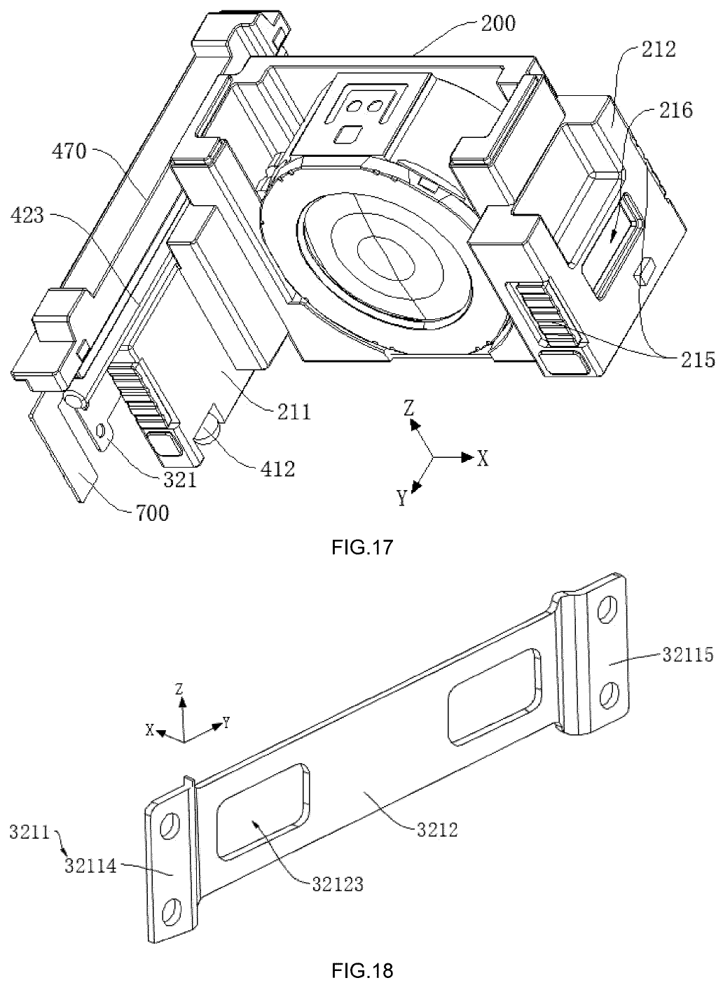

In addition, the carrier 200 further comprises a damping member 215 located at each of the light entry side and the light exit side, that is, the carrier 200 has damping members 215 at both the front and rear ends along the optical axis direction. Specifically, as shown in FIG. 13, FIG. 16 and FIG. 17, the carrier 200 is provided with a mounting groove for mounting the damping member 215 at both the front and rear ends along the optical axis direction, and the damping member 215 has a protrusion for inserting into the mounting groove, that is, a snap-fit structure is formed between the damping member 215 and the mounting groove to realize the installation of the damping member 215 on the lens carrier 210. When the carrier 200 moves along the optical axis direction, the damping member 215 can realize the functions of limiting and buffering, avoiding collision between the carrier 200 and the outer frame 100, and also avoiding the generation of sound due to collision. A glue can also be injected between the protrusion of the damping member 215 and the mounting groove to assist installation.

Furthermore, since the damping member 215 is elastic, the size of the protrusion of the damping member 215 can be slightly larger than the size of the installation groove. The protrusion of the damping member 215 has a partial extrusion deformation when inserted into the installation groove to prevent the damping member 215 from falling off after impact.

Specifically, the damping element 215 is an elastic material component, and can be implemented as a polyurethane, silicone, epoxy or polymer material component.

In some specific embodiments, the carrier 200 further comprises a friction plate 214 in frictional contact with the pre-pressing actuator assembly 300, and is used for friction between the pre-pressing actuator assembly 300 and the friction plate 214 of the carrier 200 to drive the carrier 200 to move. As shown in FIGS. 4, 6, 12 and 23, the friction plate 214 corresponds to the driving member 310 of the pre-pressing actuator assembly 300, and is extended on the first carrier side wall 211 of the carrier 200 in a direction parallel to the optical axis.

Specifically, the friction plate 214 is assembled between the carrier 200 and the pre-pressing actuator assembly 300. The friction plate 214 is implemented as an integral structure on the first carrier side wall 211 of the carrier 200, for example, the friction plate 214 and the first carrier side wall 211 are integrally formed by an insert molding process; it can also be implemented as a split structure provided on the first carrier side wall 211 of the carrier 200, for example, the friction plate 214 is connected to the carrier 200 by an adhesive. It should be understood that the friction plate 214 can increase the friction between the carrier 200 and the pre-pressing actuator assembly 300.

The friction plate 214 is made of a metal oxide plate such as zirconium oxide or aluminum oxide.

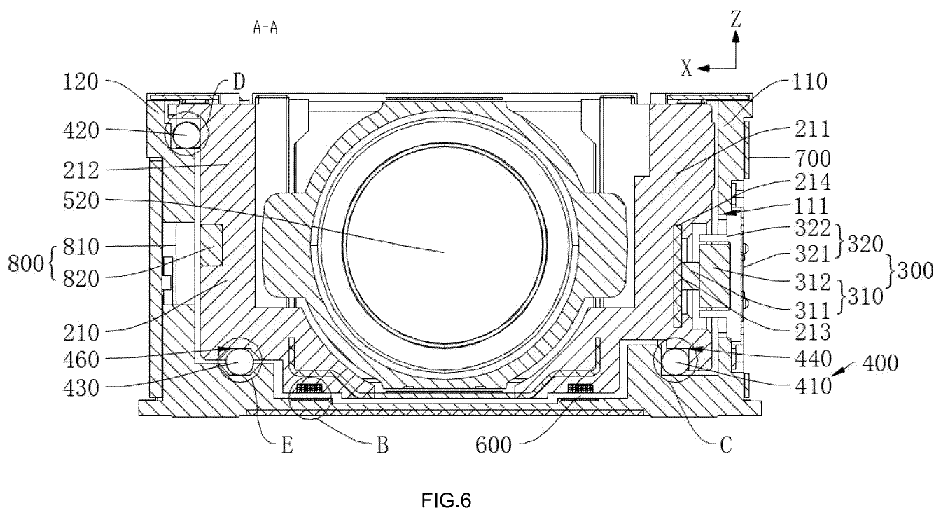

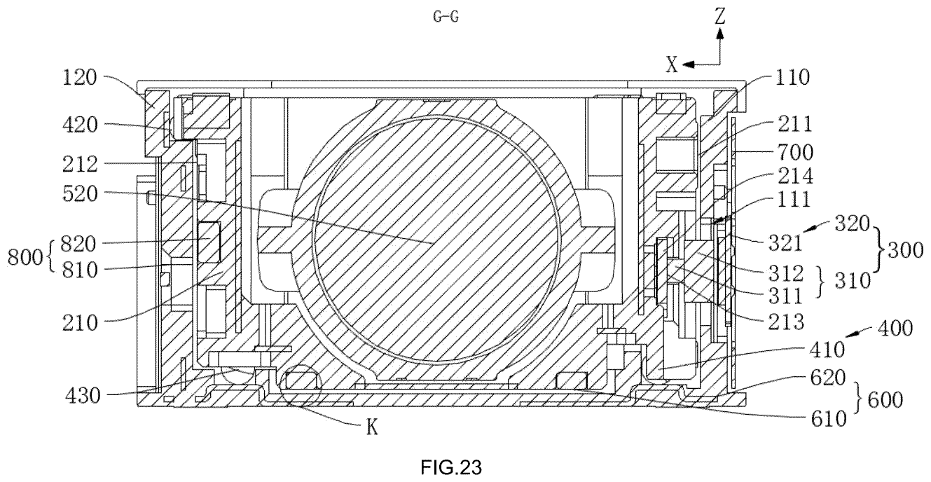

More specifically, referring to FIG. 6 and FIG. 23, the friction contact position 213 between the friction plate 214 and the pre-pressing actuator assembly 300 is located at the first carrier side wall 211 of the carrier 200. Before the driving member 310 drives the carrier 200, the pre-pressing member 320 applies the pre-pressing to the pre-pressing actuator assembly 300 to abut against the friction plate 214 of the carrier 200, so as to ensure that the friction head 311 of the pre-pressing actuator assembly 300 is frictionally connected with the friction plate 214.

It should be noted here that the friction contact position 213 mentioned in the previous and later texts refers to the position where the pre-pressing actuator assembly 300 or the first support part 410 or the second support part 420 or the third support part 430 mentioned in the later text and other elements constituting the support assembly 400 come into contact with the carrier 200 or the outer frame 100. The contact may be surface friction or point friction, rolling friction or sliding friction, but due to its uncertainty, it is not clearly shown in the figure.

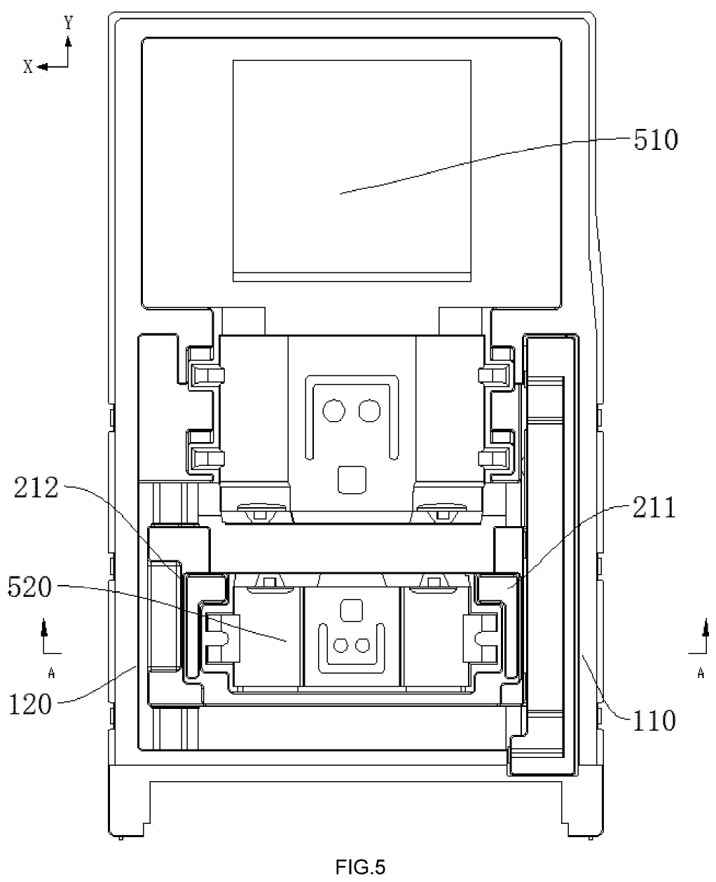

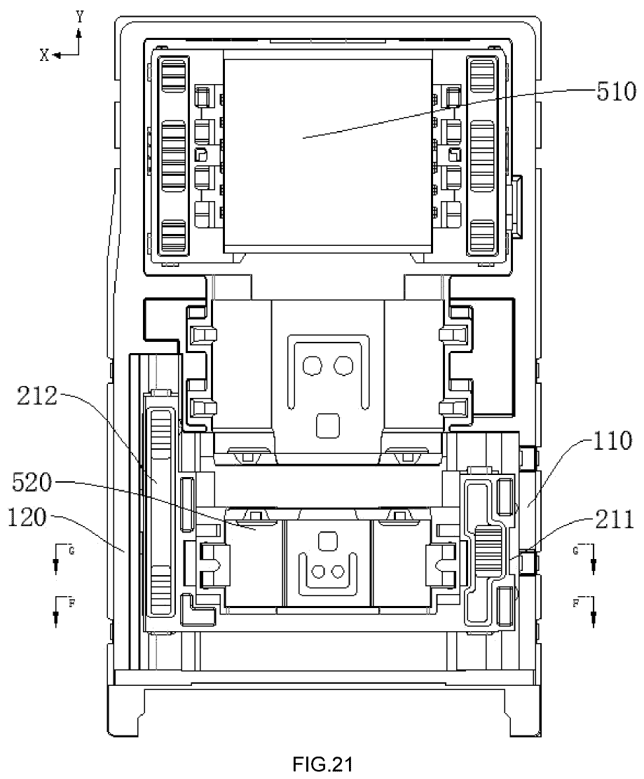

As shown in FIG. 5, FIG. 6 and FIG. 21, in the above-mentioned periscope camera module, the carrier 200 is mainly subjected to the pre-pressing along the third axis X direction (i.e., the width direction of the outer frame 100 or the carrier 200), the magnetic attracting along the first axis Z direction (i.e., the height direction of the outer frame 100 or the carrier 200), and the driving force along the second axis Y direction (i.e., the length direction of the outer frame 100 or the carrier 200, parallel to the optical axis). It should be understood that since the piezoelectric vibrator 312 of the driving member 310 causes the friction head 311 to move by vibration deformation, and when the piezoelectric vibrator 312 vibrates and deforms, the angle at which the friction head 311 abuts against the carrier 200 changes accordingly, which causes the force generated between the friction head 311 and the carrier 200 to not always be parallel to the optical axis direction, and the direction of the force has a certain inclination with respect to the plane where the side wall of the carrier 200 is located, and the action of the inclined force may cause the carrier 200 to tilt.

Furthermore, the pre-pressing member 320 provides a pre-pressing for the driving member 310, and the direction of the pre-pressing is perpendicular to the side wall of the carrier 200 along the first axis Z direction. However, due to the vibration deformation of the piezoelectric vibrator 312, the angle at which the friction head 311 abuts against the carrier 200 changes accordingly, resulting in the direction of the pre-pressing not always acting perpendicularly on the side wall of the carrier 200, but the direction of the pre-pressing has a certain inclination with respect to the plane where the side wall of the carrier 200 is located. At the same time, the piezoelectric vibrator 312 of the pre-pressing actuator assembly 300 drives the friction head 311 to move through vibration deformation. The pre-pressing member 320 will be deformed due to the vibration deformation of the piezoelectric vibrator 312, and the direction of the pre-pressing generated by it will also be inclined with respect to the plane where the side wall of the carrier 200 is located, making it possible for the carrier 200 to tilt or even overturn.

In a specific example of the present application, the pre-pressing actuator assembly 300 is extended along a direction parallel to the optical axis and is distributed on the first side wall 110 of the outer frame 100, and the pre-pressing member 320 of the pre-pressing actuator assembly 300 applies a pre-pressing force perpendicular to the optical axis direction along a direction from the first carrier side wall 211 of the carrier 200 toward the second carrier side wall 212, so as to ensure that the carrier 200 always maintains frictional contact with the pre-pressing actuator assembly 300, thereby driving the carrier 200 to move along the optical axis direction with respect to the outer frame 100 to achieve focusing and zooming functions.

When performing focusing and zooming operations, the first carrier side wall 211 of the carrier 200 will be subjected to the pre-pressing perpendicular to the optical axis direction applied by the pre-pressing actuator assembly 300. In order to better bear the pre-pressing from the pre-pressing actuator assembly 300, it is preferred that the length of the first carrier side wall 211 of the carrier 200 along the optical axis is not less than the length of the second carrier side wall 212 of the carrier 200 along the optical axis.

Correspondingly, the length of the friction plate 214 of the carrier 200 can be set to be longer to further extend the stroke of the pre-pressing actuator assembly 300.

In one embodiment, the length of the first carrier side wall 211 of the carrier 200 along the optical axis is equal to the length of the second carrier side wall 212 of the carrier 200 along the optical axis, so as to increase the setting length of the support part arranged on the opposite side of the pre-pressing actuator assembly 300 (for example, the distance between two ball bearings arranged along the optical axis), thereby increasing the support surface area formed by different support parts on the carrier 200, so as to further enhance the movement stability and parallelism of the carrier 200.

Specifically, when performing focusing and zooming operations, the first carrier side wall 211 of the carrier 200 is subjected to a preload perpendicular to the optical axis direction applied by the preload actuator assembly 300. In addition, during the movement, the carrier 200 may also tend to deviate toward the second side wall 120 of the outer frame 100, and produce an up-and-down deviation on the bottom surface of the outer frame 100. In order to prevent these deviations and ensure that the carrier 200 always moves smoothly along the optical axis direction during the entire focusing and zooming process, the support assembly 400 is carefully designed and assembled between the carrier 200 and the outer frame 100 to provide necessary support and guidance.

Since the pre-pressing actuator assembly 300 is driven on the side of the carrier 200, the pre-pressing member 320 provides a pre-pressing force perpendicular to the first carrier side wall 211 of the carrier 200, so a portion of the support members in the support assembly 400 needs to support the carrier 200 on the side of the carrier 200, which can avoid the excessive friction caused by the surface friction between the carrier 200 and the outer frame 100, and on the other hand, the parallelism of the movement of the carrier 200 can be improved by configuring the support members (such as ball bearings) and the linear grooves. If the supporting members are all placed on the opposite side (i.e., the second side) of the pre-pressing actuator assembly 300 under the action of the pre-pressing force, there will be a problem that the overturning moment of the carrier 200 is large due to the excessively long force arm, and the carrier 200 is more likely to tilt. In the state where the pre-pressing actuator assembly 300 is not powered on, the straight-line distance from the supporting member to the friction contact position 213 is the overturning force arm of the carrier 200.

Specifically, when the driving member 310 is not powered on, the straight-line distance from the friction head 311 of the driving member 310 to the supporting member is the force arm x of the driving force. According to the formula M=Fx, when x is larger, that is, when the driving member 310 is not powered on, the straight-line distance between the friction head 311 and the supporting member is greater, the overturning moment M is greater. When the carrier 200 is driven to move along the optical axis, the carrier 200 is more likely to tilt, thereby increasing the risk of the carrier 200 getting stuck and unable to move further.

In addition, when the support member is implemented as a ball bearing or other support member that is in point friction contact with the carrier 200 but has an uncertain motion state, taking a ball bearing as an example, when the ball bearing is assembled between the carrier 200 and the outer frame 100, its motion state is uncertain, and the ball bearing can switch the motion state of rolling or sliding at will, so the ball bearing may be stuck in its assembly groove during the movement of the carrier 200, which may also cause the carrier 200 to tilt or even overturn. When the support assembly 400 is implemented as multiple ball bearings, the ball bearings are in point contact with the outer frame 100 and the carrier 200 on both sides. If the carrier 200 tilts, one of the ball bearings of the support assembly 400 may not be in contact with the outer frame 100 and the carrier 200 at the same time, which may cause the carrier 200 and the ball bearing to be stuck, the carrier 200 and the ball bearing to be separated, etc., and then the carrier 200 cannot continue to move. On this basis, considering the size of the movable space at the ball bearing assembly location, the manufacturing tolerance of the outer frame 100 and the carrier 200 and the assembly tolerance therebetween may also cause the carrier 200 to tilt or get stuck.

More specifically, the support assembly 400 is implemented as a plurality of support members, wherein at least one of the support members is assembled between the first side of the outer frame 100 and the first side of the carrier 200, and at least another of the support members is assembled between the second side of the outer frame 100 and the second side of the carrier 200. In other words, at least one of the support members is assembled between the inner side wall of the outer frame 100 on which the pre-pressing actuator assembly 300 is arranged and the outer side wall of the carrier 200 opposite thereto, and at least another of the support members is assembled between the outer side wall of the outer frame 100 on which the pre-pressing actuator assembly 300 is not arranged. Between the other inner side wall of the outer frame 100 and the other outer side wall of the carrier 200 opposite thereto, that is, at least one of the support members is assembled between the first side wall 110 of the outer frame 100 and the first carrier side wall 211 of the carrier 200, and at least another of the support members is assembled between the second side wall 120 of the outer frame 100 and the second carrier side wall 212 of the carrier 200, so that the left and right side walls and/or the left and right sides of the bottom surface of the carrier 200 parallel to the optical axis direction are supported by the support members, thereby ensuring that the carrier 200 always moves along the optical axis direction. In some optional embodiments, at least two of the support members are assembled on both sides of the friction contact position 213 between the pre-pressing actuator assembly 300 and the carrier 200 in the height direction (i.e., along the thickness direction of the outer frame 100), so that when the carrier 200 moves in the optical axis direction, the deviation or even jamming of the carrier 200 in the horizontal plane and in the height direction during zooming and focusing is reduced.

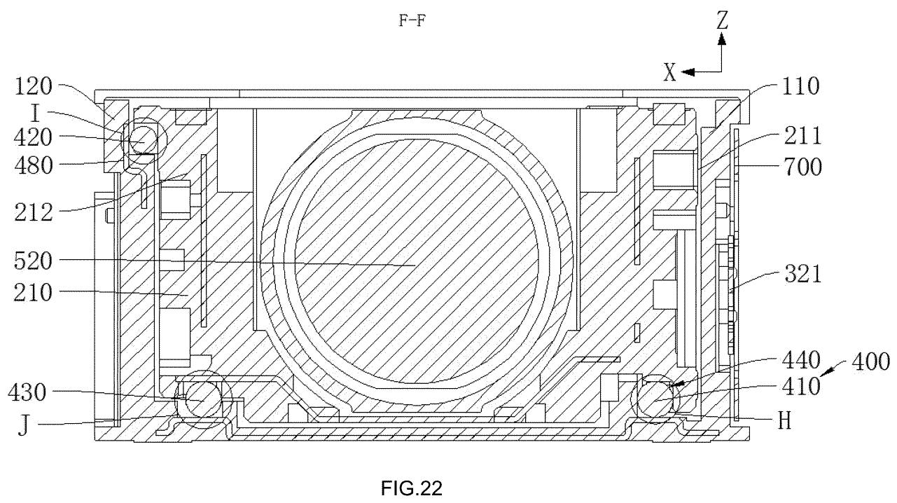

In a specific example of the present application, the support assembly 400 comprises a first support part 410 and a second support part 420, and the first support part 410 and the second support part 420 each have at least one support member. The first support part 410 is arranged on the first side wall 110 of the outer frame 100 on which the pre-pressing actuator assembly 300 is arranged, and the second support part 420 is arranged on the second side wall 120 of the outer frame 100 corresponding to the first side wall 110. As shown in FIGS. 6 and 22, under the action of pre-pressing, the first support part 410 is clamped at the bottom of the first side wall 110 of the outer frame 100 and the bottom of the first carrier side wall 211 of the carrier 200, and the second support part 420 is clamped at the top of the second side wall 120 of the outer frame 100 and the top of the second carrier side wall 212 of the carrier 200, thereby supporting the carrier 200.

Preferably, the first support part 410 and the second support part 420 are assembled on the upper and lower sides of the friction contact position 213 between the pre-pressing actuator assembly 300 and the carrier 200 in the height direction (i.e., along the thickness direction of the outer frame 100), and the distance from the first support part 410 to the friction contact position 213 along the above-mentioned height direction is equal to or similar to the distance from the second support part 420 to the friction contact position 213 along the above-mentioned height direction (the difference does not exceed 20%), so that the first support part 410 and the second support part 420 are arranged as symmetrically as possible with respect to the optical axis in the height direction, so as to provide the carrier 200 with a supporting force that is as symmetrical as possible, and reduce the risk of overturning of the carrier 200 without structural interference.

Specifically, according to the calculation formula of the torque M=Fx, M is the overturning torque, F is the pre-pressing vector, and x is the lever arm of the pre-pressing, that is, the straight-line distance from the friction contact position 213 between the pre-pressing actuator assembly 300 and the carrier 200 to the second support part 420 when the pre-pressing actuator assembly 300 is not powered on (the straight-line distance between the first support part 410 and the friction contact position 213 approaches zero). When the pre-pressing F value is constant, the overturning torque M increases with the increase of the lever arm x. When the x value is larger, that is, the distance from the friction contact position 213 between the pre-pressing actuator assembly 300 and the carrier 200 to the second support part 420 is farther, the overturning torque M is larger, and the carrier 200 is more likely to tilt when moving along the optical axis, thereby increasing the risk of the carrier 200 being stuck. Therefore, the x value can be controlled by controlling the straight-line distance between the second support part 420 and the friction contact position 213, thereby controlling the overturning torque M.

Correspondingly, the first side wall 110 of the outer frame 100 and the first carrier side wall 211 of the carrier 200 both have at least two abutting surfaces abutting against the first support part 410, and the second side wall 120 of the outer frame 100 and the second carrier side wall 212 of the carrier 200 both have at least one abutting surface abutting against the second support part 420. As shown in FIGS. 8, 9, 24 and 25, the abutting surface of the first support part 410 or the second support part 420 comprises at least one vertical surface perpendicular to the pre-pressing direction, namely the first abutting surface 112 and the second abutting surface 121, to provide abutting support for the first support part 410 or the second support part 420 under the pre-pressing.

In some embodiments, when the first support part 410 and/or the second support part 420 is implemented as being composed of two or more support members distributed in sequence along a direction parallel to the optical axis, the assembly areas on the outer frame 100 and the carrier 200 located on the first support part 410 and the second support part 420 both have assembly grooves corresponding to the support members, and each assembly groove has at least two relatively arranged abutment surfaces, as shown in FIGS. 8, 9, 24 and 25, the assembly groove is implemented as having two vertical surfaces and two horizontal surfaces, so that the support member can be abutted and supported from both vertical and horizontal directions. For example, the first abutting surface 112 on the first side wall 110 of the outer frame 100 and the third abutting surface 2111 on the first carrier side wall 211 of the carrier 200 are both vertical abutting surfaces, which abut and support the first support part 410 from both horizontal directions. The first support part 410 has horizontal abutting surfaces on the upper and lower sides, which abut and support the first support part 410 from two vertical directions; the second abutting surface 121 on the second side wall 120 of the outer frame 100 and the fourth abutting surface 2121 on the second carrier side wall 212 of the carrier 200 are both vertical abutting surfaces, which abut and support the second support part 420 from two horizontal directions; as shown in FIG. 25, the first abutting surface 112 on the first side wall 110 of the outer frame 100 and the second support part 420 are abutted against each other through an additional structure, and the additional structure is a metal part 480, so as to further adjust the manufacturing tolerance between the first abutting surface 112 on the first side wall 110 of the outer frame 100 and the second support part 420; both the outer frame 100 and the carrier 200 have horizontal abutting surfaces on the upper and lower sides of the second support part 420, which abut and support the second support part 420 from two vertical directions.

In order to reduce the risk of the carrier 200 tilting, the present application sets the support portion adjacent to one side (i.e., the first side) of the pre-pressing actuator assembly 300 as a tight fit, that is, the first support part 410 set on the same side as the pre-pressing actuator assembly 300 is a main support member; and sets the support part away from one side (i.e., the second side) of the pre-pressing actuator assembly 300 as a loose fit, that is, the second support part 420 set on the opposite side of the pre-pressing actuator assembly 300 is an auxiliary support member. As shown in FIGS. 8, 9, 24 and 25, the first support part 410 is tightly assembled between the first side wall 110 of the outer frame 100 and the first carrier side wall 211 of the carrier 200, and the second support part 420 is loosely assembled between the second side wall 120 of the outer frame 100 (or the metal part 480) and the second carrier side wall 212 of the carrier 200, that is, the first support part 410 is always in abutment with the first abutting surface 112, the third abutting surface 2111 and the horizontal abutment surfaces located on the upper and lower sides of the first support part 410, and the second support part 420 always has a certain gap between the second abutting surface 121 (or a side wall of the metal part 480), the fourth abutment surface 2121 and the horizontal abutment surface located on the upper side of the second support part 420. When the carrier 200 moves along the optical axis, the first support part 410 is used as the main support component. In this way, when the pre-pressing actuator assembly 300 is not powered on, the straight-line distance from the first support part 410 to the above-mentioned contact position 213 is smaller than the straight-line distance from the projection of the second support part 420 on the first side wall 110 of the outer frame 100 to the above-mentioned contact position 213. Since the first support part 410 is tightly fitted, the straight-line distance from the above-mentioned contact position 213 to the first support part 410 is the lever arm x corresponding to the overturning moment, so as to reduce the x value and thus reduce the overturning moment M, thereby avoiding the problem of the carrier 200 tilting or even getting stuck.

The above-mentioned tight fit and loose fit can be implemented by tolerance during assembly, for example, the tolerance between the first support part 410 and the outer frame 100 and the carrier 200 is smaller than the tolerance between the second support part 420 and the outer frame 100 and the carrier 200, for example, the tolerance of the former is 0.01 mm, and the tolerance of the latter is 0.02 mm. That is, the spacing between the first abutting surface 112 and the third abutting surface 2111 is smaller than the spacing between the second abutting surface 121 and the fourth abutting surface 2121, and the spacing between the horizontal abutting surfaces located on the upper and lower sides of the first support part 410 is smaller than the spacing between the horizontal abutting surfaces located on the upper and lower sides of the second support part 420. When the carrier 200 is not tilted, the tightly fitted first support part 410 provides main support for the carrier 200 to ensure the parallelism of the carrier 200 along the optical axis; when the carrier 200 is tilted, the gap at the loosely fitted second support part 420 can provide space for the carrier 200 to adjust its position, and when tilted to a certain angle, the second support part 420 simultaneously abuts against the outer frame 100 and the carrier 200, and in this state cooperates with the first support part 410 to jointly provide support for the carrier 200, thereby correcting the position of the carrier 200 and preventing the tilt angle of the carrier 200 from affecting the movement of the carrier 200, reducing the possibility of the carrier 200 being tilted to a certain extent, and helping to improve the imaging quality of the periscope camera module.

In some optional embodiments, the first support part 410 or the second support part 420 may be implemented as a ball bearing or other supporting point-shaped support member, and the first support part 410 and/or the second support part 420 respectively comprise two ball bearings, and the ball bearings are respectively assembled at the front and rear ends of the carrier 200 along the parallel optical axis direction, as shown in FIGS. 12, 13, 28, 29 and 30, the first support part 410 and the second support part 420 are both implemented as two ball bearings, namely, the first ball 411 and the second ball 412 constituting the first support part 410 and the third ball 421 and the fourth ball 422 constituting the second support part 420. Under the action of pre-pressing, the ball bearings are clamped between the outer frame 100 and the carrier 200 to provide more stable support and movement guidance for the carrier 200.

In some optional embodiments, the first support part 410 or the second support part 420 may be implemented as a guide rod or other surface-supported member, which extends in a direction parallel to the optical axis and is assembled between the outer frame 100 and the carrier 200 to ensure the parallelism and stability of the movement of the carrier 200. As shown in FIGS. 14 to 17 and FIG. 30, the first support part 410 is implemented as a first ball 411 and a second ball 412, and the second support part 420 is implemented as a top guide rod 423.

In some specific examples, as shown in FIGS. 6, 8, 9, 22 and 24, when the first support part 410 and the second support part 420 are implemented as two ball bearings, the corresponding abutting surface of the first side wall 110 of the outer frame 100 and the corresponding abutting surface of the first carrier side wall 211 of the carrier 200 are respectively recessed into the outer frame 100 and into the carrier 200 to form at least one pair of L-shaped guide grooves 440 with opposite opening directions, that is, the first abutting surface 112, the second abutting surface 121, the third abutting surface 2111 or the fourth abutting surface 2121 can all be connected to an adjacent horizontal abutting surface to form an L-shaped guide groove 440; as shown in FIGS. 6, 8, 9, 25, 31, 32 and 33, a side wall of the metal part 480 can also be connected to an adjacent horizontal abutting surface to form an L-shaped guide groove 440. Under the action of pre-pressing, the four inner walls of each pair of L-shaped guide grooves 440 are simultaneously clamped on the outer side of the ball bearing of the first support part 410, that is, the first abutting surface 112, the third abutting surface 2111 and the horizontal abutting surfaces on the upper and lower sides of the ball bearing of the first support part 410 all abut the ball bearing of the first support part 410 to achieve a tight fit of the first support part 410; except for the bottom surface, a certain gap is maintained between the other three inner walls of the pair of L-shaped guide grooves 440 and the ball bearing of the second support part 420, that is, the second abutting surface 121, the fourth abutting surface 2121 and the horizontal abutting surface on the upper side of the ball bearing of the second support part 420 all maintain a certain gap with the ball bearing of the first support part 410 to achieve a loose fit of the second support part 420 and prevent the ball bearing of the first support part 410 or the second support part 420 from loosening or falling off.

In one embodiment of the present application, the ball size of the first support part 410 on the same side as the pre-pressing actuator assembly 300 is larger than the ball size of the second support part 420 on the opposite side of the pre-pressing actuator assembly 300. It should be understood that the ball bearing of the first support part 410 is located at the bottom of the first side, and the ball bearing of the second support part 420 is located at the top of the second side. Such an arrangement makes it possible for the ball bearing of the first support part 410 to be arranged between the bottom of the first side wall 110 of the outer frame 100 and the bottom of the first carrier side wall 211 of the carrier 200 when the periscope camera module falls or is impacted because it needs to support the entire carrier 200, resulting in a greater force on the ball bearing of the first support part 410, making it easier to form a pit.

Furthermore, since the first support part 410 is tightly fitted, that is, the four sides of the ball bearing of the first support part 410 are in contact with the L-shaped guide groove 440, and the second support part 420 is loosely fitted, that is, there is a gap between at least one side of the ball bearing of the second support part 420 and the L-shaped guide groove 440 to alleviate the impact on the ball bearing of the second support part 420, when the periscope camera module falls or is impacted, the ball bearing of the first support part 410 is subjected to a greater force and is more likely to form a pit.

Specifically, the ball size of the first support part 410 is designed to be larger, so as to disperse the force when the ball bearing of the first support part 410 is impacted, thereby reducing the degree of the pit generated in the first support part 410.

In some optional embodiments, a metal support is provided on the first side wall 110 of the outer frame 100. The metal support is located at the bottom of the second support part 420 and supports the second support part 420 upward on its top surface to provide a support plane for the ball bearing of the second support part 420 to improve the smoothness of the movement of the second support part 420 and avoid the formation of pits in the guide groove or debris on the outer frame 100 after the ball is compressed.

As shown in FIGS. 6, 8, 9, 22, 24 and 25, the spacing between the pair of L-shaped guide grooves 440 clamped on the outer side of the ball bearing of the second support part 420 is greater than the spacing between the pair of L-shaped guide grooves 440 clamped on the outer side of the ball bearing of the first support part 410. In some optional embodiments, the horizontal spacing between the pair of L-shaped guide grooves 440 clamped on the outer side of the ball bearing of the second support part 420 is greater than the horizontal spacing between the pair of L-shaped guide grooves 440 clamped on the outer side of the ball bearing of the first support part 410, so as to achieve a tight fit of the first support part 410 and a loose fit of the second support part 420. Further, as shown in FIGS. 6, 8, 9, 22, 24 and 25, the horizontal spacing and vertical spacing of a pair of L-shaped guide grooves 440 on the outside of the ball clamped on the second support part 420 are greater than the horizontal spacing and vertical spacing of a pair of L-shaped guide grooves 440 on the outside of the ball clamped on the first support part 410, so as to achieve a loose fit of the second support part 420, so that the carrier 200 in the tilted state has sufficient adjustment space to avoid getting stuck, so as to ensure the stable movement of the ball in the L-shaped guide groove 440.

Specifically, two ball bearings constituting the same support portion are located in two pairs of L-shaped guide grooves 440, which are arranged in a direction parallel to the optical axis but are not connected to each other, that is, each ball is located in a pair of L-shaped guide grooves 440 to avoid interference between the two ball bearings.

The length of the L-shaped guide groove 440 along the optical axis is greater than the diameter of the ball bearing, so that the ball can move along the optical axis in the L-shaped guide groove 440. It should be understood that the longer the length of the L-shaped guide groove 440 along the optical axis, the greater the chance that the ball bearing can roll purely, and the smaller the friction coefficient of pure rolling, so that the friction force on the carrier 200 is smaller, and the movement of the carrier 200 along the optical axis is smoother.

In some specific examples, the length of the L-shaped guide groove 440 accommodating the first support part 410 along the optical axis direction may be equal to the length of the L-shaped guide groove 440 accommodating the second support part 420 along the optical axis direction to ensure a long moving stroke of the carrier 200.

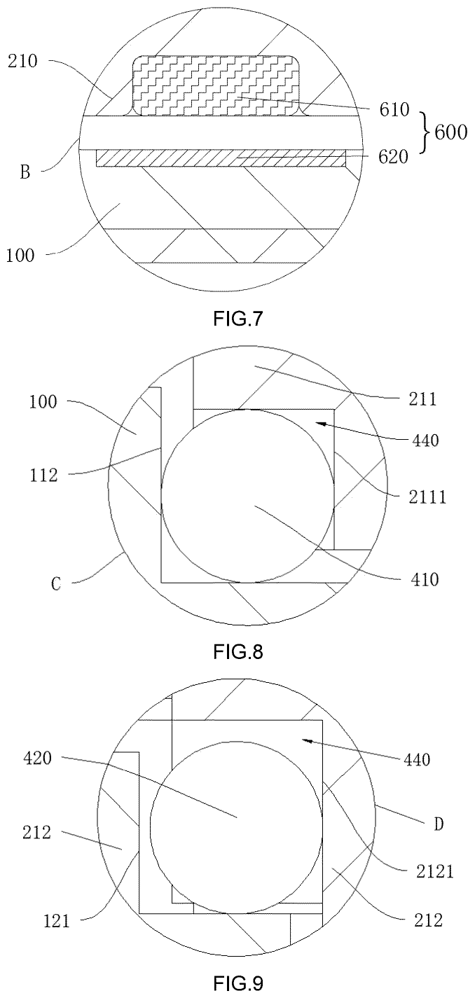

Since the carrier 200 moves along the optical axis, in order to ensure that the support assembly 400 is always clamped and does not fall off, as shown in FIGS. 6 and 7, a magnetic attracting assembly 600 is arranged between the carrier 200 and the outer frame 100, so that the carrier 200 is subjected to a magnetic attracting force toward the outer frame 100 during the movement along the optical axis to clamp the support assembly 400, thereby reducing the offset of the carrier 200 moving along the optical axis and maintaining its parallelism.

In some specific examples, as shown in FIG. 6, FIG. 7 and FIG. 22, the magnetic attracting assembly 600 is implemented to be located between the bottom of the carrier 200 and the bottom of the outer frame 100, and the magnetic attracting assembly 600 comprises a magnetic attracting magnet 610 and a yoke 620, that is, the magnetic attracting magnet 610 is arranged on one of the carrier 200 and the outer frame 100, and the yoke 620 is arranged on the other of the carrier 200 and the outer frame 100. Preferably, the magnetic attracting magnet 610 is arranged on the bottom surface of the carrier 200, and the yoke 620 is arranged on the outer frame 100 at a position corresponding to the magnetic attracting magnet 610, and the magnetic attracting magnet 610 and the yoke 620 are both extended along the optical axis direction.

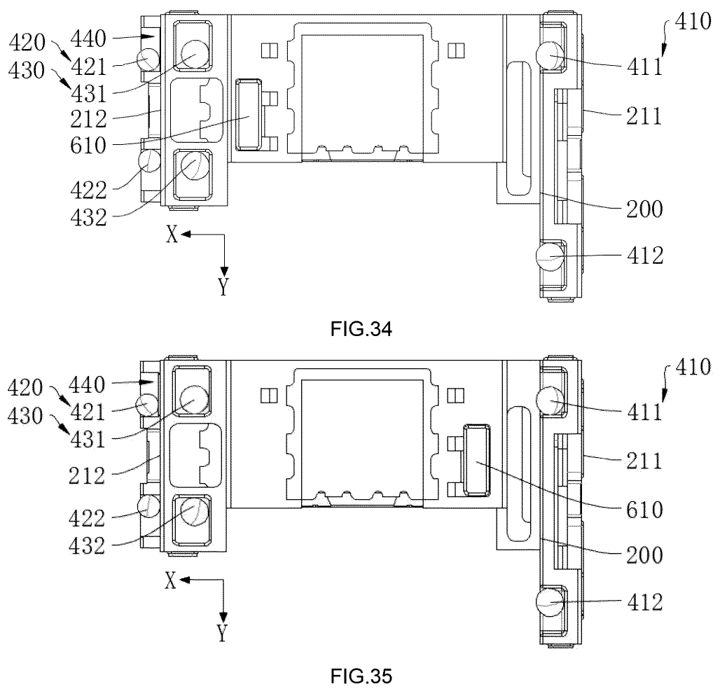

In some specific embodiments, the magnetic attracting assembly 600 and the first support part 410 are symmetrically arranged at the bottom of the carrier 200, that is, at least one magnetic attracting magnet 610 and the first support part 410 are symmetrically arranged at the bottom of the carrier 200 in the width direction. As shown in FIG. 34, the magnetic attracting magnet 610 is arranged on the other side of the bottom of the carrier 200 away from the first support part 410, and the yoke 620 is correspondingly arranged at the bottom of the side wall of the outer frame 100 that does not have the pre-pressing actuator assembly 300. Since the first support part 410 is tightly fitted to the first side of the outer frame 100 and the first side of the carrier 200, the magnetic attracting assembly 600 is placed at the bottom of the carrier 200 closer to the second side of the outer frame 100 and the second side of the carrier 200 in the width direction, and a downward magnetic attracting force is generated on the carrier 200, so that the bottom of the carrier 200 is subjected to downward force on both symmetrical sides in the width direction, so as to ensure the stability of the carrier 200 on the outer frame 100.

The magnetic attracting assembly 600 comprises at least one magnetic attracting magnet 610 and a yoke 620. In some optional embodiments, the number of the magnetic attracting magnet 610 is at least two, and at least two of the magnetic attracting magnets 610 are symmetrically distributed on the bottom surfaces of both sides of the bottom of the carrier 200 along the width direction, and extended in a direction parallel to the optical axis. The yoke 620 is arranged on the outer frame 100 at a position corresponding to the magnetic attracting magnet 610, that is, on the projection of the magnetic attracting magnet 610 on the outer frame 100, and extended in a direction parallel to the optical axis. The two groups of magnetic attracting magnets 610 and the yoke 620 shown in FIGS. 6, 7, 23 and 27 generate magnetic attracting on both sides of the bottom of the carrier 200. The two groups of magnetic attracting magnets 610 are symmetrically arranged at the bottom of the carrier 200, so that the carrier 200 is subjected to the symmetrical downward magnetic attracting force perpendicular to the optical axis, so as to further reduce the offset of the carrier 200 when moving and maintain its parallelism of movement. In some optional embodiments, the magnetic attracting assembly 600 further comprises a magnetic attracting magnet 610 arranged on one side wall or both side walls of the carrier 200 and a yoke 620 on the inner wall of the outer frame 100 at a corresponding position, which is used to generate a magnetic attracting force in the direction of the third axis X to ensure the movement parallelism of the carrier 200.

In some specific embodiments, at least one magnetic attracting magnet 610 is provided on one side or on both symmetrical sides of the bottom surface of the carrier 200 along the third direction X, as shown in FIGS. 12, 13, 15, 16, 28, 29 and 30, a magnetic attracting magnet 610 is provided on each side of the bottom surface of the carrier 200, specifically, the length of the magnetic attracting magnet 610 is not less than half of the length of the carrier 200 (along the optical axis direction).

In some embodiments, two magnetic attracting magnets 610 are provided on both sides of the bottom surface of the carrier 200, and the two magnetic attracting magnets 610 on the same side are distributed along the optical axis. The length of each magnetic attracting magnet 610 is not less than one third of the length of the carrier 200 (along the optical axis) to ensure the movement stability of the carrier 200 in the outer frame 100.

In some specific embodiments, the yoke 620 is disposed at the projection of the magnetic attracting magnet 610 on the outer frame 100 and extended along the optical axis direction, wherein the yoke 620 can be fixed to the outer frame 100 by bonding, clamping, nesting, welding or fastener connection. Specifically, in order to ensure that the carrier 200 is always subjected to a downward magnetic attracting force when moving, the length of the yoke 620 along the optical axis direction is not less than the moving stroke of the carrier 200.

Preferably, the length of the yoke 620 is not less than the sum of half the length of the carrier 200 along the optical axis and the moving stroke of the carrier 200, so as to avoid the carrier 200 being offset due to the fact that the magnetic attracting force on the carrier 200 is smaller when the carrier 200 moves to one end of the yoke 620 due to the forward or backward setting position of the magnetic attracting magnet 610.

In some optional embodiments, when the carrier 200 is implemented as two carriers 200 arranged sequentially along the optical axis, the yokes 620 corresponding to the two carriers 200 are located in the same direction parallel to the optical axis or at different positions in a third direction X and both extend along the optical axis.

Specifically, when the magnetic yokes 620 corresponding to the two carriers 200 are located in the same direction parallel to the optical axis, the magnetic yoke 620 can be implemented as an integral magnetic yoke 620 or two segmented magnetic yokes 620 corresponding to the moving strokes of the two carriers 200 to cover the moving strokes of the two carriers 200.

In some specific embodiments, the yoke 620 comprises a planar section 621 and an edge section 623. The planar section 621 covers the projection of the magnetic attracting magnet 610 on the outer frame 100 and the moving range of the carrier 200, and is used to generate magnetic attracting force between the magnetic attracting magnet 610 on the carrier 200. The edge section 623 connects the planar section 621 and the outer frame 100.

In some optional embodiments, the magnetic attracting assembly 600 is implemented as a group of the magnetic attracting assemblies 600 and is symmetrically arranged on both sides of the bottom of the carrier 200 with the first support part 410 in the third direction X, and the magnetic attracting magnet 610 is arranged on the other side of the bottom of the carrier 200 away from the first support part 410. The yoke 620 can be implemented to be extended to the first support part 410 in the third direction X, or is extended to cover the width of the carrier 200, or is extended to only cover the projection of the magnetic attracting magnet 610, that is, the planar section 621 of the yoke 620 covers the projection of the magnetic attracting magnet 610, and the edge section 623 of the yoke 620 can be implemented to be extended from one side or both sides of the planar section 621 along the third direction X to the first support part 410, or to be extended to cover the width of the carrier 200, or to be extended to only cover one side of the bottom surface of the carrier 200.

Specifically, the width of the magnetic attracting magnet 610 in the third direction X is not less than one quarter of the width of the carrier 200 to ensure that the two sides of the bottom of the carrier 200 are subjected to similar or identical downward forces, thereby preventing the carrier 200 from deflecting.

In some optional embodiments, the yoke 620 further comprises a bending section 622 located between the planar section 621 and the edge section 623, as shown in FIGS. 22 and 28, the bending section 622 is protruded upward from the opposite sides of the planar section 621 and the edge section 623 to form a supporting surface, which supports the first supporting portion 410 upward at the top. At this time, the planar section 621 covers the projection of the magnetic attracting magnet 610 on the outer frame 100 in the width direction and extends to the first supporting portion 410 on one side.

Specifically, the planar section 621 covers the projection of the magnetic attracting magnet 610 on the outer frame 100 along the third direction X, and is respectively connected to an edge section 623 and a bending section 622 on both sides, and the bending section 622 is connected to another edge section 623 on the other side to cover the bottom surface of the carrier 200, so that the magnetic attracting force on the carrier 200 is more stable.

Furthermore, the planar section 621 comprises a projection area 6211 and a connection area 6212, as shown in FIG. 28, the projection area 6211 only covers the projection of the magnetic attracting magnet 610, and the connection area 6212 connects the projection area 6211 with other segments of the yoke 620 and/or connects two adjacent projection areas 6211.

Specifically, when the magnetic attracting magnet 610 is only located on one side of the bottom of the carrier 200 along the third direction X away from the first support part 410, the projection area 6211 of the planar section 621 only covers the projection of the magnetic attracting magnet 610 on the outer frame 100 along the third direction X, and the connection area 6212 of the planar section 621 connects the edge section 623 and the bending section 622; when the magnetic attracting magnet 610 is symmetrically arranged on two sides of the bottom of the carrier 200 along the third direction X, the projection area 6211 of the planar section 621 covers only the projection of the magnetic attracting magnet 610 on the outer frame 100 along the third direction X, and the connection area 6212 of the planar section 621 connects the projection area 6211 with the edge section 623 and the bending section 622, and connects two adjacent projection areas 6211.

Preferably, the connection area 6212 of the planar section 621 has a hollow hole to further reduce the mass of the yoke 620.

In some embodiments of the present application, the yoke 620 is implemented as a metal material strip that can attract the magnetic attracting magnet 610, that is, it can be mass-produced, and the yoke 620 is cut into the required area after manufacturing to improve manufacturing efficiency. In addition, the yoke 620 has a larger area. The larger the metal pressing area, the more conducive it is to ensure the flatness of the area on the outer frame 100 corresponding to the carrier 200.

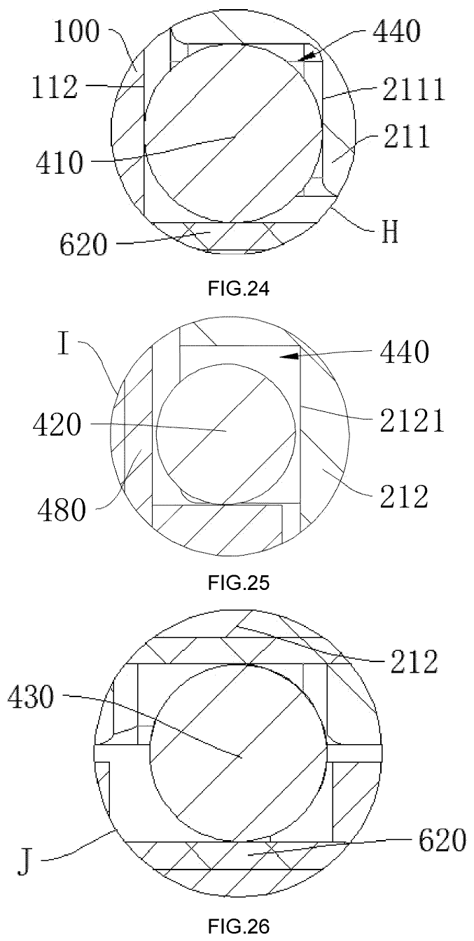

In a specific example of the present application, the support assembly 400 further comprises a third support part 430 assembled between the outer frame 100 and the carrier 200. Under the magnetic attracting of the magnetic attracting assembly 600, the third support part 430 is clamped between the bottom of the outer frame 100 and the bottom of the carrier 200. As shown in FIG. 6, FIG. 8, FIG. 22 and FIG. 24, under the action of the magnetic attracting force, the first support part 410 and the third support part 430 are clamped between the bottom of the outer frame 100 and the bottom of the carrier 200, and are respectively located on both sides of the bottom of the carrier 200. The third support part 430 and the first support part 410 are arranged symmetrically with respect to the optical axis along the width direction of the carrier 200 and the outer frame 100 as much as possible (the optical axis direction is the length direction of the carrier 200 and the outer frame 100), so as to provide the carrier 200 with as symmetrical support force as possible, and reduce the risk of the carrier 200 tilting.

Correspondingly, the second side wall 120 of the outer frame 100 and the second carrier side wall 212 of the carrier 200 each have at least one abutting surface abutting against the third support part 430. As shown in FIG. 6 and FIG. 22, the abutting surface of the third support part 430 comprises at least two horizontal surfaces perpendicular to the direction of the magnetic attracting force, so as to provide abutting support for the upper and lower sides of the third support part 430 under the action of the magnetic attracting force.

Specifically, the third support part 430 is clamped between the bottom of the second side wall 120 of the outer frame 100 and the bottom of the second carrier side wall 212 of the carrier 200. When the carrier 200 is subjected to pre-pressing and moves along the optical axis, the carrier 200 is mainly supported by the tightly fitted first support part 410 and the loosely fitted second support part 420, and maintains movement along the optical axis under the magnetic attracting between the two groups of magnetic attracting magnets 610 and the magnetic yoke 620 on both sides of the bottom surface of the carrier 200.

In order to reduce the probability of the carrier 200 tilting toward the second side wall 120 of the outer frame 100 under the action of pre-pressing, the third support part 430 has a certain adjustment gap in the direction parallel to the pre-pressing direction, and the third support part 430 has no adjustment gap in the direction of the magnetic attracting force, so that the ball bearing of the third support part 430 is always clamped under the action of the magnetic attracting force, even if its corresponding pair of assembly grooves may be horizontally misaligned under the action of pre-pressing, the ball bearing of the third support part 430 can still move stably in the pair of assembly grooves. The above-mentioned adjustment gap can be implemented by tolerance in the assembly process. For example, the left and right spacing of the pair of assembly grooves of the ball bearing of the third support part 430 is greater than the upper and lower spacing.

As shown in FIGS. 6 and 22, the first support part 410 and the third support part 430 are respectively located at the bottom of the first carrier side wall 211 and the bottom of the second carrier side wall 212 of the carrier 200, and the second support part 420 and the third support part 430 are respectively located at the top and the bottom of the second carrier side wall 212 of the carrier 200. During the movement of the carrier 200, the first support part 410 and the second support part 420 are clamped between the carrier 200 and the outer frame 100 under the action of pre-pressing to provide horizontal support for the carrier 200, and the first support part 410 and the third support part 430 are clamped between the carrier 200 and the outer frame 100 under the action of magnetic attracting to provide vertical support for the carrier 200.

More specifically, the first support part 410 has a supporting effect on the carrier 200 under the action of the pre-pressing and the magnetic attracting force, so the first support part 410 needs to be restricted in the direction parallel to the pre-pressing and in the direction parallel to the magnetic attracting force at the same time. As shown in FIGS. 6, 8, 9, 10 and 22, the first support part 410 needs to be restricted in the horizontal direction and the vertical direction perpendicular to the optical axis at the same time. The second support part 420 plays a supporting role under the action of the pre-pressing, so the second support part 420 needs to be restricted in the direction parallel to the pre-pressing, and can have a certain movement space in the direction parallel to the magnetic attracting force, that is, the second support part 420 needs to be restricted in the horizontal direction perpendicular to the optical axis, and can have a certain movement space in the vertical direction perpendicular to the optical axis. The third support part 430 plays a supporting role under the action of the magnetic attracting force, so the third support part 430 needs to be restricted in the direction parallel to the magnetic attracting force, and can have a certain movement space in the direction parallel to the pre-pressing, that is, the third support part 430 needs to be restricted in the vertical direction perpendicular to the optical axis, and can have a certain movement space in the horizontal direction perpendicular to the optical axis.

Correspondingly, when the first support part 410 and the third support part 430 are symmetrically arranged at the bottom of the carrier 200, the magnetic attracting magnet 610 is implemented as two magnetic attracting magnets 610 symmetrically arranged at the first support part 410 and the third support part 430, and the yokes 620 are sequentially provided with the edge section 623, the bending section 622 and the planar section 621 from both sides to the center, and the planar section 621 covers the projections of the two magnetic attracting magnets 610 on the outer frame 100, and the edge section 623 and the bending section 622 are symmetrically distributed on both sides of the planar section 621 in the width direction, and the two bending sections 622 are respectively located at the bottom of the first support part 410 and the third support part 430, and support the first support part 410 and the third support part 430 upward on the top surface.

In some optional embodiments, the third support part 430 can be implemented as two ball bearings which are respectively mounted on the front and rear ends of the carrier 200 along the parallel optical axis direction. Under the action of magnetic attracting, the ball bearings are clamped between the outer frame 100 and the carrier 200 to provide more stable support and movement guidance for the carrier 200. As shown in FIGS. 12, 15, 16 and 30, the third support part 430 is implemented as a fifth ball 431 and a sixth ball 432.

In some optional embodiments, the third support part 430 may be implemented as a guide rod having the same structure as the top guide rod 423 implemented as the second support part 420, and extending in a direction parallel to the optical axis and assembled between the outer frame 100 and the carrier 200 to ensure the parallelism and stability of the movement of the carrier 200.

In some specific examples, when the third support part 430 is implemented as two ball bearings, the corresponding abutting surface of the second side wall 120 of the outer frame 100 is recessed into the outer frame 100, and the corresponding abutting surface of the second carrier side wall 212 of the carrier 200 is recessed into the carrier 200, forming at least one pair of V-shaped guide grooves with opposite opening directions or further including a three-sided guide groove with a flat bottom surface, i.e., an inclined side wall guide groove 460. Under the action of magnetic attracting, the top wall and the bottom wall in the inner wall of the inclined side wall guide groove 460 are simultaneously clamped on the outside of the ball bearings of the third support part 430, thereby preventing the ball bearings of the third support part 430 from loosening or falling off.

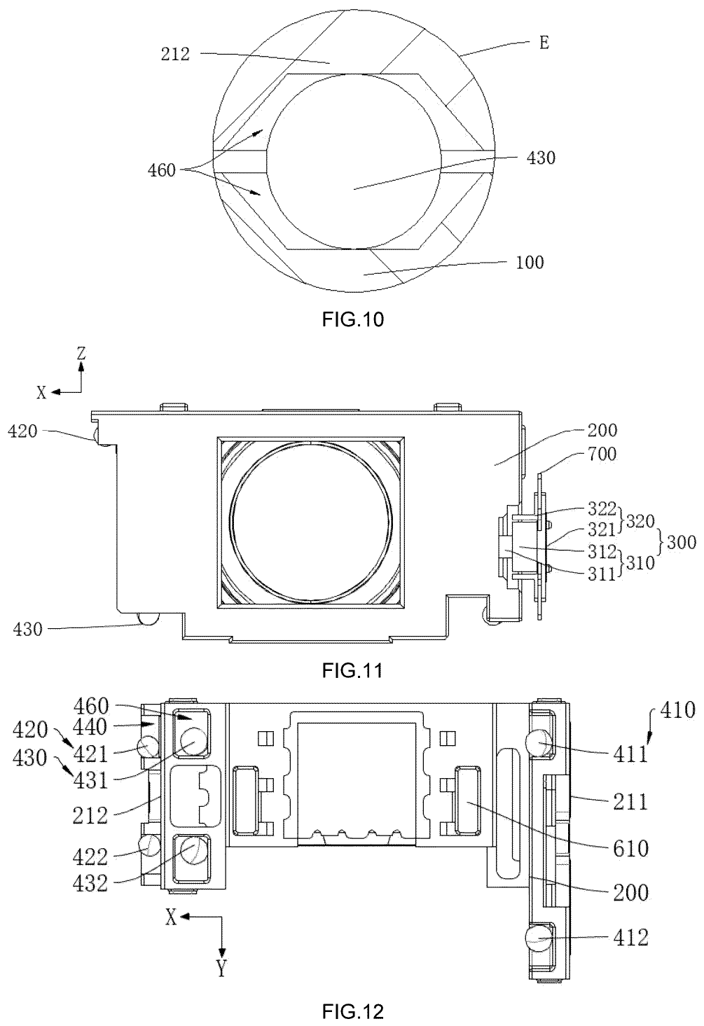

As shown in FIG. 10, the top wall and the bottom wall in the inner wall of each pair of inclined side wall guide grooves 460 clamp the ball bearings of the third support part 430 from the upper and lower sides to ensure that the ball bearings are clamped and stably move in the inclined side wall guide grooves 460. The horizontal width of the inclined side wall guide grooves 460 is greater than its upper and lower heights or its depth. The third support part 430 can have a certain movement space in the direction parallel to the pre-pressing, so that the carrier 200 in the inclined state has sufficient adjustment space to avoid being stuck. As shown in FIG. 22 and FIG. 26, an auxiliary metal piece is provided at the bottom of the carrier 200. The bottom surface of the auxiliary metal piece and the top surface of the bending section 622 of the yoke 620 clamp the ball bearings of the third support part 430 from the upper and lower sides, replacing each pair of inclined side wall guide grooves 460 to realize the assembly of the ball bearings of the third support part 430.

Specifically, the two ball bearings constituting the same support part are located in two pairs of inclined side wall guide grooves 460 which are arranged in a direction parallel to the optical axis but are not connected to each other, that is, each ball bearing is located in a pair of inclined side wall guide grooves 460 to avoid interference between the two ball bearings.

In some specific examples, when the third support part 430 is implemented as a guide rod, the guide rod structure is the same as the top guide rod 423 implemented as the second support part 420, and the corresponding abutting surface of the second side wall 120 of the outer frame 100 and the corresponding abutting surface of the second carrier side wall 212 of the carrier 200 are respectively recessed downward or upward to form a U-shaped guide groove 450 with an upward or downward opening to assemble the guide rod. A pressing block for pressing the guide rod is provided at the opening of the U-shaped guide groove 450 to prevent the guide rod from tilting in the U-shaped guide groove 450.

In the specific example of the present application, under the magnetic attracting of the magnetic attracting assembly 600, the first support part 410 and the third support part 430 are respectively clamped on two sides of the bottom of the carrier 200, that is, the magnetic attracting assembly 600 has a certain degree of inhibitory effect on the tilting tendency of the carrier 200 on the second carrier side wall 212. On this basis, it can be seen from the above that the smaller the overturning arm from the friction head 311 of the driving member 310 to the support assembly 400, the smaller the overturning moment, and the lower the risk of the carrier 200 overturning.

Therefore, the present application provides another embodiment, in which the second support part 420 is also arranged on the first side like the first support part 410, and is arranged adjacent to the driving member 310, that is, the second support part 420 is assembled on the top of the first side wall 110 of the outer frame 100 and the top of the first carrier side wall 211 of the carrier 200, so that the first support part 410 and the second support part 420 provide corresponding pre-pressing support to the carrier 200 at different heights on the same side, which can eliminate the farther force arm and further reduce the risk of tilting of the carrier 200. In this embodiment, the first support part 410 is still the main support structure, and the second support part 420 is the auxiliary support structure, that is, the first support part 410 is a tight fit, and the second support part 420 is a loose fit, so as to ensure that the carrier 200 always has a small overturning moment to reduce the risk of tilting of the carrier 200.

The first support part 410, the second support part 420 and the driving member 310 are arranged on the same side, and the first carrier side wall 211 of the carrier 200 has a longer size, so there is no significant difference in the support surfaces of the first support part 410 and the second support part 420 located on the first carrier side wall 211 of the carrier 200. That is, the first support part 410 and the second support part 420 both have two end sides in the direction parallel to the optical axis, and the spacing between the two end sides of the first support part 410 is similar to the spacing between the two end sides of the second support part 420. When the first support part 410 is implemented as a ball bearing, and the second support part 420 is implemented as a top guide rod 423 or a ball bearing, the two end sides of the first support part 410 are two ball bearings, and the two end sides of the second support part 420 are the two ends of the top guide rod 423 or two ball bearings, and the ball spacing of the first support part 410 is similar to the ball spacing of the second support part 420 or the effective length of the top guide rod 423. In this way, the friction contact position 213 between the friction head 311 and the carrier 200 does not need to be eccentric, that is, when the pre-pressing actuator assembly 300 is not powered on, the straight-line distance from the friction contact position 213 to the first support part 410 and the straight-line distance from the friction contact position 213 to the second support part 420 are equal, which helps to improve the stability of the carrier 200, and when the carrier 200 is driven to move along the optical axis, the point of action of the friction head 311 on driving the carrier 200 is not easy to move out of the range of the side support surface.

In this embodiment, the second support part 420 can be implemented as a ball bearing or a top guide rod 423. When the second support part 420 is implemented as a ball bearing, the carrier 200 and the outer frame 100 are respectively provided with L-shaped guide grooves 440 to clamp the ball bearing of the second support part 420 between the L-shaped guide grooves 440. As shown in FIG. 9, the opening of the L-shaped guide groove 440 of the carrier 200 is along the pre-pressing direction, and the opening of the L-shaped guide groove 440 of the outer frame 100 faces the opposite direction. The ball bearing of the second support part 420 has an adjustment space perpendicular to the pre-pressing direction in the pair of L-shaped guide grooves 440, and the ball bearing of the second support part 420 is clamped in the pair of L-shaped guide grooves 440 in the left and right directions parallel to the pre-pressing under the effect of the pre-pressing. Therefore, when no pre-pressing is applied, the carrier 200 may shake left and right, and the ball bearing of the second support part 420 may fall off.

In order to prevent the second support part 420 from falling off, the second support part 420 is implemented as a top guide rod 423 as an auxiliary support for the first support part 410. The corresponding abutting surface of the first side wall 110 of the outer frame 100 and the corresponding abutting surface of the first carrier side wall 211 of the carrier 200 are respectively recessed downward or upward to form a U-shaped guide groove 450 with an opening upward or downward to assemble the top guide rod 423. As shown in FIGS. 14 to 17 and FIG. 30, the top surface of the first carrier side wall 211 of the carrier 200 is provided with a U-shaped guide groove 450, and the second support part 420 is implemented as a top guide rod 423, which is placed in the U-shaped guide groove 450, and the two ends of the top guide rod 423 are fixed on the outer frame 100, so that even if no pre-pressing is applied, the carrier 200 is not likely to shake, and the top guide rod 423 will not fall off. In order to enable the top guide bar 423 to abut against the carrier 200 and reduce the gap between the top guide bar 423 and the carrier 200 due to assembly, the top of the U-shaped guide groove 450 is provided with a pressing fitting 470 for pressing the top of the carrier 200 to prevent the top guide bar 423 from tilting in the U-shaped guide groove 450. In one embodiment of the present application, the pressing fitting 470 is installed from top to bottom corresponding to the U-shaped guide groove 450 of the carrier 200, and has a protrusion to abut against the top guide bar 423, and the pressing fitting 470 is fixed to the outer frame 100. In some embodiments, the U-shaped guide groove 450 can also be applied to the case where the first support part 410 or the second support part 420 is implemented as a ball bearing.

As shown in FIG. 6, the first support part 410 is arranged on the same side as the pre-pressing actuator assembly 300, that is, the driving member 310 is arranged closer to the first support part 410 with a larger distance between the ball bearings. In this way, on the one hand, the space utilization is more reasonable. This is because the driving member 310 and the pre-pressing member 320 are both extended along the optical axis direction, and the corresponding side wall of the carrier 200 located on the first side also needs to extend along the optical axis direction, that is, the first carrier side wall 211 of the carrier 200 needs to have a certain length, and the first support part 410 is arranged on the bottom surface of the first carrier side wall 211 of the carrier 200, and there can also be a longer space to arrange the two ball bearings of the first support part 410. In contrast, the second carrier side wall 212 of the carrier 200 does not need to be provided with the driving member 310, and it can be set to a shorter length to accommodate the second support part 420 and the third support part 430. This not only makes the overall structure of the periscope camera module more compact, but also helps to reduce the size of the periscope camera module. On the other hand, since the optical focus stroke in the periscope camera module is large, this design also helps the ball bearings to always support the carrier 200 during long strokes.

Since the pre-pressing actuator assembly 300 applies pressure and force to the friction plate 214 during actual operation, the longer the length of the friction plate 214 is, the longer the driving stroke of the corresponding driving member 310 is, and the corresponding length of the first carrier side wall 211 of the carrier 200 is also longer. Preferably, the length of the second carrier side wall 212 of the carrier 200 is less than the length of the first carrier side wall 211, and there are only ball bearings on the second carrier side wall 212 of the carrier 200. The distance between the ball bearings can be adjusted, and as long as the distance between the two ball bearings of the first supporting portion 410 is large enough, the overall structural balance can be met. Therefore, the second carrier side wall 212 of the carrier 200 does not need to be elongated to have the same length as the first carrier side wall 211.

More specifically, when the first support part 410 and the second support part 420 are implemented as two ball bearings, the ball spacing between the two ball bearings of the first support part 410 is not less than the ball spacing of the second support part 420, and the greater the distance between the two ball bearings along the optical axis direction, the more stable the support for the carrier 200.

In some optional embodiments, as shown in FIG. 12, FIG. 13, FIG. 28 and FIG. 30, the ball spacing between the two ball bearings of the first support part 410 is greater than the ball spacing between the two ball bearings of the second support part 420, and in some preferred embodiments it is more than 1.5 times. Further, in some optional embodiments, the spacing between the two L-shaped guide grooves 440 clamping the first support part 410 is more than 1.5 times the spacing between the two L-shaped guide grooves 440 or U-shaped guide grooves 450 clamping the second support part 420, wherein the above-mentioned ball spacing and all guide groove spacings are spacings along the direction parallel to the optical axis. When the first support part 410 and the driving member 310 are arranged on the same side of the first side, and the second support part 420 is arranged on the second side, the first support part 410 is arranged at the bottom of the first carrier side wall 211 of the carrier 200, and the second support part 420 is located at the top of the second carrier side wall 212 of the carrier 200. The first support part 410 and the second support part 420 are symmetrically arranged with respect to the optical axis in the height direction, and the friction head 311 of the driving member 310 and the friction contact position 213 of the carrier 200 are located on the first carrier side wall 211 of the carrier 200, which is closer to the first support part 410. Since the ball spacing between the two ball bearings of the first support part 410 is large, the first support part 410 provides a larger support range for the carrier 200. When the carrier 200 is driven to move along the optical axis, the friction contact position 213 of the friction head 311 and the carrier 200 is less likely to move out of the support range provided by the first support part 410, and the carrier 200 is more stably supported. The carrier 200 is supported in the height direction, which effectively prevents the carrier 200 from tilting or overturning; when the first support part 410, the second support part 420 and the driving member 310 are arranged on the same side, a side support surface located on the first carrier side wall 211 of the carrier 200 is formed between the four ball bearings of the first support part 410 and the second support part 420. Compared with some embodiments in which the ball spacing between the first support part 410 and the second support part 420 is the same, the larger the ball spacing of the first support part 410, the larger the coverage range of the side support surface, and the larger the coverage value range along the direction parallel to the optical axis, so that the friction contact point (i.e., the friction contact position 213) of the friction head 311 of the driving member 310 on the first carrier side wall 211 of the carrier 200 is always located within the side support surface, thereby preventing the friction contact position 213 from moving out of the side support surface during the movement of the carrier 200, resulting in insufficient support for the carrier 200 in the pre-compression direction, thereby causing the carrier 200 to tilt.

Further, when the driving member 310 is not powered on, the friction contact position 213 between the friction head 311 of the driving member 310 and the carrier 200 is arranged adjacent to the first support part 410, that is, when the driving member 310 is not powered on, the straight-line distance from the friction contact position 213 to the second support part 420 is greater than the straight-line distance from the friction contact position 213 to the first support part 410. In other words, the height of the friction head 311 of the driving member 310 is arranged as adjacent to the first support part 410 as possible. Since the ball spacing of the first support part 410 is greater than the ball spacing of the second support part 420, the closer the height of the friction head 311 is to the first support part 410, the wider the range covered by the side support surface, the less likely the point of action of the friction head 311 on the carrier 200 is to move out of the side support surface, the better the support effect on the carrier 200, and the more the point of action of the friction head 311 on the carrier 200 can be kept within the range of the ball support, and the tilt of the carrier 200 can be avoided as much as possible.

More specifically, when the carrier 200 moves along the optical axis, the magnetic attracting magnet 610 will also move with the movement of the carrier 200, and the corresponding point of action of the magnetic attracting force on the carrier 200 will also move. The first support part 410 and the third support part 430 both have two end sides parallel to the optical axis, and the spacing between the two end sides of the first support part 410 is not less than the spacing between the two end sides of the third support part 430. When the first support part 410 and the third support part 430 are implemented as two ball bearings, the two end sides of the first support part 410 and the third support part 430 are both two ball bearings, and the ball spacing between the two ball bearings of the first support part 410 is not less than the ball spacing of the third support part 430. If the distance between the two ball bearings of the first support part 410 is equal to the distance between the two ball bearings of the third support part 430, the first support part 410 and the third support part 430 will form an approximately rectangular ball support surface. When the carrier 200 is driven to move along the optical axis, there is a risk that the point of action of the magnetic attracting on the carrier 200 will move out of the ball support surface. If the point of action of the magnetic attracting moves out of the range of the ball support surface, a torque will be generated, which may easily cause the carrier 200 to tilt or flip (the straight-line distance from the point of action of the magnetic attracting to the line connecting the two ball bearings in the width direction is the lever arm). Therefore, the point of action of the magnetic attracting must always be kept within the range of the ball support surface.

Preferably, as shown in FIGS. 12, 15, 28 and 30, the ball spacing between the two ball bearings of the first support part 410 is greater than the ball spacing between the two ball bearings of the third support part 430, and in some preferred embodiments, it is more than 1.5 times. Further, in some optional embodiments, the spacing between the two L-shaped guide grooves 440 clamping the first support part 410 is more than 1.5 times the spacing between the two oblique side wall guide grooves 460 clamping the third support part 430, wherein the above-mentioned ball spacing and all guide groove spacings are spacings along the direction parallel to the optical axis. A magnetic support surface located on the bottom surface of the carrier 200 is formed between the four ball bearings of the first support part 410 and the third support part 430. The ball spacing of the first support part 410 is greater than the ball spacing of the third support part 430. On the one hand, the area of the magnetic support surface is increased so that the magnetic attracting effect of the magnetic component 600 on the bottom surface of the carrier 200 is always located within the magnetic support surface, so that the carrier 200 is supported more stably, and the carrier 200 is prevented from detaching or tilting during movement or falling; on the other hand, the magnetic attracting force generated between the magnetic attracting magnet 610 and the yoke 620 clamps the first support part 410 and the third support part 430 between the bottom surface of the carrier 200 and the middle top surface of the outer frame 100, so that the carrier 200 is always supported, reducing the magnetic attracting effect on the carrier 200 and the risk of corresponding support failure, and reducing the probability of the carrier 200 tilting due to this. Furthermore, the magnetic attracting assembly 600 is disposed at the bottom of the carrier 200 adjacent to the first support part 410 to ensure that the point of action of the magnetic attracting force is always located within the magnetic attracting support surface to prevent the carrier 200 from tilting.

Furthermore, by placing the magnetic attracting magnet 610 adjacent to the first support part 410, it is possible to prevent the point of action of the magnetic attracting force from moving out of the range of the magnetic support surface to a greater extent, thereby preventing the carrier 200 from tilting to a greater extent.

In some preferred embodiments, when the driving member 310 is not powered on, when the second support part 420 is arranged on the second side, the straight-line distance from the second support part 420 to the driving member 310 is not equal to the straight-line distance from the third support part 430 to the driving member 310, that is, the second support part 420 and the third support part 430 are not located in the same height direction, so as to provide more stable support for the carrier 200.

In one embodiment of the present application, the number of the magnetic attracting magnet 610 is one, and a groove for accommodating the magnetic attracting magnet 610 is provided at the bottom of the carrier 200. The magnetic attracting magnet 610 is arranged in the groove at the bottom surface of the carrier 200, and at least a portion of the magnetic attracting magnet 610 is exposed to generate a magnetic attracting force with respect to the yoke 620 located on the outer frame 100.

One of the magnetic attracting magnets 610 is arranged adjacent to the first support part 410, as shown in FIG. 35, the distance between the magnetic attracting magnet 610 and the first support part 410 is smaller than the distance between the magnetic attracting magnet 610 and the second support part 420, and on the ball support part formed between the two ball bearings of the first support part 410 and the two ball bearings of the second support part 420, the position of the magnetic attracting magnet 610 is closer to the first support part 410 with a larger ball spacing, that is, because the ball spacing of the first support part 410 is larger, the first support part 410 and the second support part 420 form a ball support surface that is approximately a right-angled trapezoid, so that the support area of the ball bearings adjacent to the first support part 410 is larger, and when the carrier 200 is driven to move along the optical axis, the point of action of the magnetic attracting force on the carrier 200 can be located in the larger ball support surface, which can avoid the point of action of the magnetic attracting force from moving out of the range of the ball support surface to a greater extent, and avoid the tilt of the carrier 200 to a greater extent.

In another embodiment of the present application, the number of the magnetic attracting magnets 610 is two, and the two magnetic attracting magnets 610 are symmetrically arranged at the bottom of the carrier 200 with respect to the optical axis, so that the point of action of the magnetic attracting force can be located at the midpoint of the line connecting the two magnetic attracting magnets 610. In the ball support surface of the approximately right-angled trapezoid that can be formed by the first support part 410 and the third support part 430, the magnetic attracting force can move toward or away from the hypotenuse of the right-angled trapezoid, and the point of action of the magnetic attracting force on the carrier 200 can have a larger moving space without exceeding the range of the ball support surface, thereby avoiding the tilt of the carrier 200.

In some embodiments of the present application, the first support part 410, the second support part 420, and the third support part 430 are all implemented as two ball bearings arranged along the optical axis direction.

In one embodiment, the ball size of the third support part 430 is equal to the ball size of the first support part 410. Since the first support part 410 and the third support part 430 are arranged relatively at the bottom of the carrier 200, ball bearings of the same size can provide more stable support for the carrier 200 at the bottom, further reducing the occurrence of tilting of the carrier 200.

In one embodiment of the present application, the size of the ball bearing of the second support part 420 is smaller than the size of the ball bearing of the first support part 410 and the third support part 430. It should be understood that the ball bearings of the first support part 410 and the third support part 430 are located at the bottom of the carrier 200, and the ball bearings of the second support part 420 are located at the top of the carrier 200. Such an arrangement makes it possible for the ball bearings of the first support part 410 and the third support part 430 to be respectively arranged between the bottom of the first side wall 110 of the outer frame 100 and the bottom of the first carrier side wall 211 of the carrier 200, and between the bottom of the second side wall 120 of the outer frame 100 and the bottom of the second carrier side wall 212 of the carrier 200, when the periscope camera module falls or is impacted, because they need to support the entire carrier 200, the ball bearings are respectively arranged between the bottom of the first side wall 110 of the outer frame 100 and the bottom of the second carrier side wall 212 of the carrier 200, resulting in a greater force on the ball bearings of the first support part 410 and the third support part 430, and more likely to form pits.

Furthermore, since the first support part 410 and the third support part 430 are tightly fitted in the direction of the magnetic attracting force, that is, the upper and lower sides of the ball bearings of the first support part 410 and the third support part 430 abut against the ball groove (the ball bearings of the first support part 410 abut against the L-shaped guide groove 440, and the ball bearings of the third support part 430 abut against the inclined side wall guide groove 460), and the second support part 420 is loosely fitted, that is, there is a gap between at least one side of the ball bearings of the second support part 420 and the ball groove (that is, the L-shaped guide groove 440) to alleviate the impact on the ball bearings of the second support part 420, when the periscope camera module falls or is impacted, the ball bearings of the first support part 410 and the third support part 430 are subjected to a greater force and are more likely to form pits.

Specifically, the ball sizes of the first support part 410 and the third support part 430 are designed to be larger, which can disperse the force acting on the ball bearings of the first support part 410 and the third support part 430 when they are impacted, and reduce the degree of pits generated in the first support part 410 and the third support part 430.

In one embodiment of the present application, the diameter of the ball bearing of the first support part 410 is 1 mm, and the diameter of the ball bearing of the second support part 420 is 0.8 mm. As shown in FIGS. 6, 8, 12, 13, 22 and 34, the L-shaped guide groove 440 for accommodating the ball bearing of the second support part 420 is formed by the top of the carrier 200 being recessed inward and downward. The diameter of the ball bearing of the second support part 420 is small, which can reduce the thickness of the side wall of the carrier 200 on the second side, that is, the thickness of the first carrier side wall 211 of the carrier 200, thereby reducing the width dimension of the periscope camera module.

In other embodiments, the ball size of the second support part 420 may also be equal to the ball size of the first support part 410.

Therefore, in the present application, the ball sizes of the first support part 410 and the third support part 430 are designed to be larger, which can disperse the force when the first support part 410 and the third support part 430 are impacted and reduce the situation where pits are generated in the first support part 410 and the third support part 430.

In a specific example of the present application, the pre-pressing actuator assembly 300 comprises a driving member 310 and a pre-pressing member 320 which are arranged on the first side wall 110 of the outer frame 100. The driving member 310 is located between the pre-pressing member 320 and the first carrier side wall 211 of the carrier 200. The pre-pressing member 320 applies a pre-pressing force perpendicular to the first carrier side wall 211 of the carrier 200 to the driving member 310 so as to abut against the first carrier side wall 211 of the carrier 200, thereby realizing the side driving of the carrier 200 by the pre-pressing actuator assembly 300. In order to sense the actual moving position of the carrier 200 in real time and better cooperate with the driving of the carrier 200 by the driving member 310, the periscope camera module further comprises a position sensing assembly 800 which comprises a position sensing element 810 and a position sensing magnet 820. As shown in FIGS. 6 and 13, the position sensing element 810 is arranged on the second side wall 120 of the outer frame 100 and is arranged opposite to the pre-pressing actuator assembly 300. The position sensing magnet 820 is arranged on the second carrier side wall 212 of the carrier 200 at a position corresponding to the position sensing element 810. As shown in FIGS. 6, 13, 16, 17, 29 and 30, a sensing magnet groove 216 for installing the position sensing magnet 820 is provided on the second carrier side wall 212 of the carrier 200.

In some specific embodiments, the driving member 310 comprises a piezoelectric vibrator 312 and a friction head 311 arranged on the side of the piezoelectric vibrator 312 facing the carrier 200. As shown in FIGS. 6, 11, 13 and 37, the friction head 311 and the pre-pressing member 320 are respectively located on two sides of the piezoelectric vibrator 312. The friction head 311 is abutted against the first carrier side wall 211 of the carrier 200 through the pre-pressing member 320. The piezoelectric vibrator 312 frictionally connects the friction head 311 and the carrier 200 through its own vibration or piezoelectric actuation, and drives the carrier 200 to move.

Specifically, the piezoelectric vibrator 312 is a substrate having an inverse piezoelectric effect and shrinking or expanding according to the polarization direction and the electric field direction, and can be used by polarizing the substrate in the thickness direction of a single crystal, polycrystalline ceramic, polymer, etc. The inverse piezoelectric effect refers to the mechanical deformation of a dielectric when an electric field is applied in the polarization direction of the dielectric when a potential difference is generated. The piezoelectric vibrator 312 has the effect of ultrasonic oscillation, that is, it realizes a swaying reciprocating motion or an elliptical motion on a specifically set electrode layer, thereby being able to drive the friction head 311 to perform a swaying reciprocating motion or an elliptical motion, and then through the friction between the friction head 311 and the outer wall of the carrier 200, the carrier 200 is driven to move with respect to the outer frame 100.

In some specific examples, the piezoelectric vibrator 312 is arranged on the first side wall 110 of the outer frame 100 along a direction parallel to the extension direction of the optical axis, and the friction head 311 is protrudingly arranged on the side of the piezoelectric vibrator 312 facing the carrier 200. The number of the friction heads 311 can be implemented as one or two or more. Under the vibration or piezoelectric actuation of the piezoelectric vibrator 312, the friction head 311 contacts and rubs with the first carrier side wall 211 of the carrier 200, and drives the carrier 200 to move.

Preferably, the friction head 311 is implemented as two friction heads 311 spaced apart along the extension direction of the piezoelectric vibrator 312 or along the extension direction of the optical axis, and the two friction heads 311 can cooperate with each other to drive the long-stroke movement of the carrier 200. Further, the setting position of the friction head 311 on the piezoelectric vibrator 312 can be matched with the mode of the piezoelectric vibrator 312. The piezoelectric vibrator 312 is bent and vibrated or piezoelectrically actuated in a mode of one crest and one trough in its thickness direction. The friction head 311 is arranged at the corresponding position of the crest and trough to increase the friction between the friction head 311 and the carrier 200, so as to improve the driving effect on the carrier 200.

In some specific examples, the friction head 311 and the piezoelectric vibrator 312 can be implemented as an integrated structure or a detachable structure, and the friction head 311 can be fixed to the piezoelectric vibrator 312 by bonding, clamping, nesting, welding, or fastener connection. More specifically, the connection between the friction head 311 and the piezoelectric vibrator 312 is a surface connection to ensure the connection strength, and the friction head 311 can move with the deformation of the piezoelectric vibrator 312.

In some specific examples, the friction head 311 is made of wear-resistant material, for example, it can be made of various high-hardness wear-resistant ceramic materials, such as aluminum oxide, zirconium oxide, silicon carbide ceramics, or high-wear-resistant metal materials, carbon fiber materials, or composite materials of ceramics, metal particles and polymers, etc., so as to improve the wear resistance of the friction head 311, which is beneficial to increase the friction between the carrier 200 and the friction head 311, which is beneficial to improve the driving efficiency, and due to the wear resistance, it is beneficial to extend the service life of the friction head 311.

In some specific examples, in order to improve the driving performance of the pre-pressing actuator assembly 300, the piezoelectric vibrator 312 can be made of piezoelectric ceramic material or piezoelectric single crystal material. The piezoelectric vibrator 312 can be a single-layer ceramic body or a single-layer single crystal, or a multi-layer ceramic body or a multi-layer single crystal, for example, lead zirconate titanate (PZT)-based piezoelectric ceramics, potassium sodium niobate (KNN)-based piezoelectric ceramics, barium titanate (BT)-based piezoelectric ceramics, lead magnesium niobate-lead indium niobate (PMN-PT)-based piezoelectric single crystals, etc.

In a specific example of the present application, the pre-pressing member 320 applies a pre-pressing toward the carrier 200 to the driving member 310, so that the friction head 311 of the driving member 310 always maintains friction contact with the first carrier side wall 211 of the carrier 200. Since the piezoelectric vibrator 312 is mechanically deformed when driven, the pre-pressing member 320 has an elastic deformation portion (elastic portion 3212) for abutting against the piezoelectric vibrator 312 and a fixing portion 3211 for mounting the piezoelectric vibrator 312, so as to fix the piezoelectric vibrator 312 and apply a pre-pressing toward the carrier 200 to the driving member 310, so as to maintain friction contact between the friction head 311 and the carrier 200.

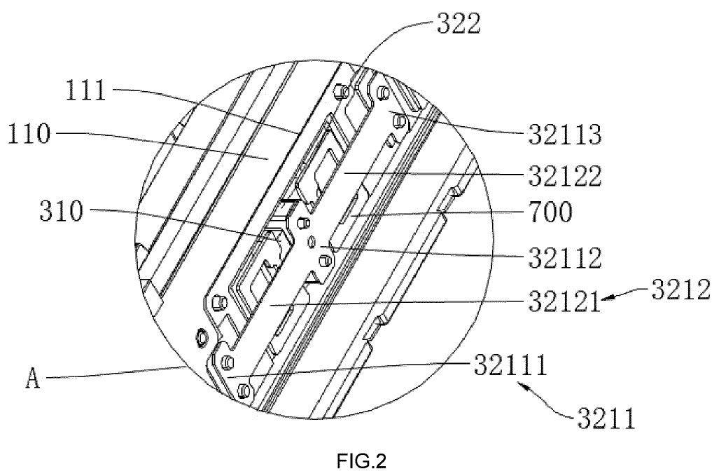

In some specific embodiments, as shown in FIG. 2, the pre-pressed member 320 is implemented as a resilient piece 321 extending in a direction parallel to the optical axis. The resilient piece 321 assembles the piezoelectric vibrator 312 on the first side wall 110 of the outer frame 100. The resilient piece 321 has a first fixed end 32111, a second fixed end 32112 and a third fixed end 32113 distributed in a direction parallel to the optical axis. A first elastic portion 32121 is provided between the first fixed end 32111 and the second fixed end 32112. A second elastic portion 32122 is disposed between the second fixed end 32112 and the third fixed end 32113. The first fixed end 32111, the second fixed end 32112 and the third fixed end 32113 are fixed to the first side wall 110 of the outer frame 100 by welding, riveting or bonding. The first elastic portion 32121 and the second elastic portion 32122 are both extended parallel to the optical axis direction to connect two adjacent fixed ends and use their own elastic deformation properties to apply appropriate pre-pressing to the driving member 310. In some optional embodiments, the pre-pressing member 320 can also be implemented as elastic glue.

More specifically, the pre-pressed piece 320 comprises the above-mentioned resilient piece 321 and at least one clamping piece 322 extended from the resilient piece 321 toward the side of the carrier 200, as shown in FIGS. 6, 11 and 37, one side of the clamping piece 322 is connected to the second fixed end 32112 of the resilient piece 321, and the side of the clamping piece 322 toward the carrier 200 has a first clamping arm and a second clamping arm, and the first clamping arm and the second clamping arm extend toward the carrier 200 in a direction perpendicular to the optical axis, and are used to clamp the piezoelectric vibrator 312 to ensure its installation stability.

Since the piezoelectric vibrator 312 drives the friction head 311 through its own bending vibration or piezoelectric actuation, the larger the extension size of the clamping arm, the larger the overlap area between the piezoelectric vibrator 312 and the clamping arm of the clamping sheet 322, and the greater the impact on the vibration or piezoelectric actuation of the piezoelectric vibrator 312. Therefore, the clamping arm size of the clamping sheet 322 should not be greater than ½ of the side wall length (i.e., the length along the optical axis direction) of the piezoelectric vibrator 312, so as to avoid the clamping arm of the clamping sheet 322 being clamped too tightly or the overlap area of the clamping arm and the piezoelectric vibrator 312 being too large, resulting in the suppression of the vibration or piezoelectric actuation of the piezoelectric vibrator 312.

In some specific embodiments, the resilient piece 321 is implemented as a planar resilient piece, and may also be implemented as a resilient piece 321 with a bent structure.

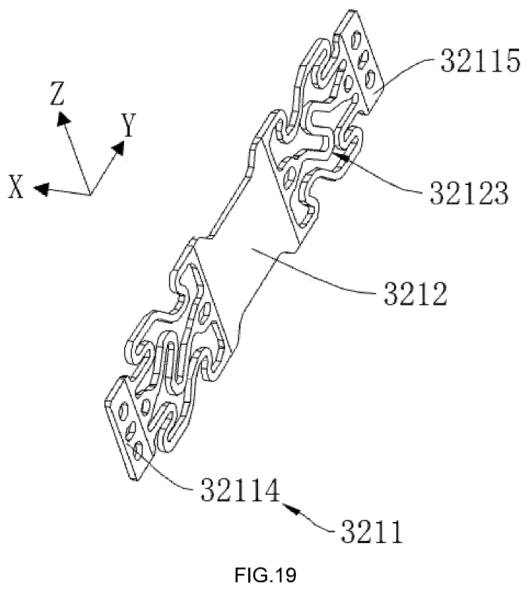

In some optional embodiments, the resilient piece 321 comprises at least two fixing parts 3211 arranged on the first side wall 110 of the outer frame 100 and an elastic part 3212 connecting two adjacent fixing parts 3211, as shown in FIGS. 18 and 19, the fixing part 3211 comprises a first fixing portion 32114 and a second fixing portion 32115 fixed on the first side wall 110 of the outer frame 100, and the first fixing portion 32114 and the second fixing portion 32115 can be fixed to the outer side of the first side wall 110 of the outer frame 100 by welding, riveting or bonding. The elastic part 3212 is extended in a direction parallel to the optical axis and has a bent portion 3213 toward the piezoelectric vibrator 312 to apply a pre-pressing to the friction head 311 on the piezoelectric vibrator 312 to abut against the carrier 200.

Furthermore, an electric conductive assembly 700 is disposed on the piezoelectric vibrator 312, and the electric conductive assembly 700 is assembled between the piezoelectric vibrator 312 and the elastic part 3212 to facilitate the assembly and driving of the driving member 310.

In some embodiments, in the pre-pressing direction, i.e., perpendicular to the optical axis, the elastic part 3212 covers the side of the piezoelectric vibrator 312 facing away from the carrier 200, i.e., at least a portion of the elastic part 3212 overlaps with the side of the piezoelectric vibrator 312, so that the side of the piezoelectric vibrator 312 is supported by the elastic portion 3212, which can not only keep the piezoelectric vibrator 312 on a flat plane, but also avoid the situation where the pre-pressing is uneven. the area of the elastic part 3212 is not less than the area of the side of the piezoelectric vibrator 312 facing away from the carrier 200.

Specifically, the elastic part 3212 comprises a bonding part and a deformation part. In the direction perpendicular to the optical axis, the bonding part overlaps with the side of the piezoelectric vibrator 312 facing away from the carrier 200 to fix the piezoelectric vibrator 312 to the elastic part 3212, and the deformation part does not overlap with the side of the piezoelectric vibrator 312 facing away from the carrier 200 to generate pre-pressing on the driver 310 by elastic deformation. The setting of the elastic part 3212 makes the actual motion state of the piezoelectric vibrator 312 of the driver 310 closer to the design value, reduces the influence of the external environment on the piezoelectric vibrator 312, and can also prevent the vibration or piezoelectric actuation of the piezoelectric vibrator 312 from being transmitted to the outer frame 100, causing the vibration or piezoelectric actuation of the outer frame 100.

Along the direction perpendicular to the optical axis, the bonding part is the overlapping part of the elastic part 3212 and the side of the piezoelectric vibrator 312 facing away from the carrier 200, and the deformation part is the non-overlapping part of the elastic part 3212 and the side of the piezoelectric vibrator 312 facing away from the carrier 200, that is, the bonding part is used to connect the piezoelectric vibrator 312 and the elastic part 3212, and the deformation part is used to generate pre-pressing on the piezoelectric vibrator 312.

Furthermore, according to the formula: K=F/X, wherein K is stiffness (or elastic coefficient), F is elastic force, and X is displacement of deformation, reducing the K value of the elastic part 3212 actually reduces the sensitivity of the elastic force to displacement. When the K value of the elastic part 3212 is small, the fluctuation of the elastic force caused by the fluctuation of the displacement will become smaller, that is, the fluctuation of the pre-pressing of the elastic part 3212 on the driving member 310 becomes smaller, thereby making the friction force between the friction head 311 and the carrier 200 more uniform and consistent.

Specifically, as shown in FIGS. 18 and 19, the deformed portion of the elastic part 3212 has a hollow structure 32123 to reduce the thickness of the deformed portion. When the material of the deformed portion is thinner, the K value of the elastic part 3212 is reduced, so that the deformed portion of the elastic part 3212 is more suitable for the bending vibration or piezoelectric actuation of the piezoelectric vibrator 312. The longer the extension length of the deformed portion along the length direction of the first side wall 110 of the outer frame 100 is, the smaller the K value (stiffness or elastic coefficient) of the elastic part 3212 is, and the easier it is to produce elastic deformation.

The K value of the elastic part 3212 is small, so it can deform, thereby reducing the pre-pressing change caused by material tolerance and assembly tolerance in the contact system composed of the carrier 200, the driving member 310, and the elastic part 3212, thereby improving the consistency of the pre-pressing actuator assembly 300.

Specifically, the preload provided by the elastic part 3212 of the preload member 320 is transmitted to the piezoelectric vibrator 312 of the driving member 310, so that the friction head 311 located on the piezoelectric vibrator 312 abuts against the carrier 200. Since the K value of the elastic part 3212 is relatively small, it will produce different degrees of deformation due to the tolerance, thereby reducing the difference in preload of the preload actuator assembly 300 under different tolerances.

Further, in some embodiments, the bending part 3213 makes the fixed portion 3211 and the elastic part 3212 located in different planes, that is, the plane where the fixing part 3211 is located and the plane where the elastic part 3212 is located are parallel to each other and have a certain distance, so that the fixing part 3211 is fixedly connected to the first side wall 110 of the outer frame 100, and the elastic part 3212 is arranged on the side of the piezoelectric vibrator 312 facing away from the carrier 200, and applies a pre-pressing in the direction perpendicular to the optical axis to the piezoelectric vibrator 312, thereby achieving frictional contact between the friction head 311 and the carrier 200. Compared with the design of the planar spring piece 321 in which the fixing part 3211 and the elastic part 3212 are located in the same plane, the existence of the bending part 3213 can also reduce the K value of the elastic portion 3212, so that the fluctuation of the pre-pressing of the elastic part 3212 acting on the driving member 310 becomes smaller, thereby making the friction between the friction head 311 and the carrier 200 more uniform and consistent.

Since the elastic part 3212 is connected to the first fixing portion 32114 and the second fixing portion 32115, the number of the bending parts 3213 is also two, including the first bending portion 32131 and the second bending portion 32132, the first bending portion 32131 connects the first fixing portion 32114 and the elastic part 3212, and the second bending portion 32132 connects the second fixing portion 32115 and the elastic part 3212.

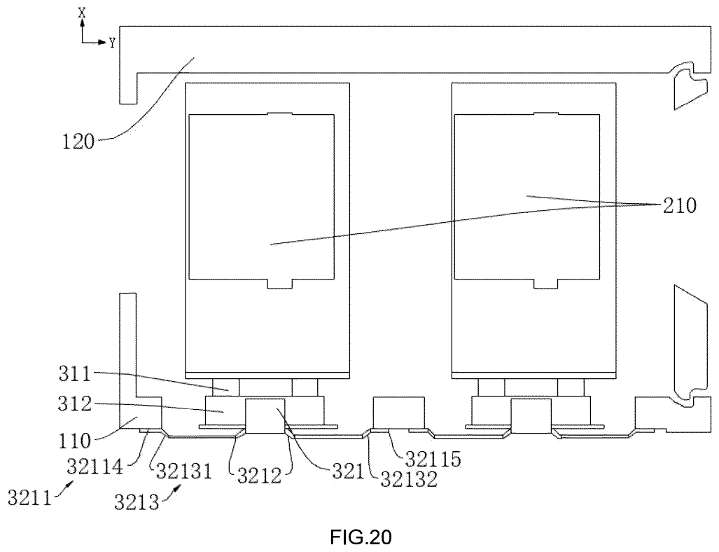

In some embodiments, referring to FIG. 20, the bending part 3213 inclinedly connects the fixing part 3211 and the elastic part 3212, and a plane where the bending part 3213 is located intersects with a plane where the fixing part 3211 is located and a plane where the elastic part 3212 is located.

Specifically, the first bending portion 32131 and the second bending portion 32132 connect the first fixing portion 32114, the elastic part 3212 and the second fixing portion 32115 in a relative oblique direction, so that the pre-pressing component has an opening extending outward from the elastic part 3212 and gradually increasing in size, that is, the extension line of the first bending portion 32131 intersects with the extension line of the second bending portion 32132. In the pre-pressing component, the elastic part 3212 protrudes outward from the fixing part 3211, that is, the distance from the plane where the elastic part 3212 is located to the carrier 200 is greater than the distance from the plane where the fixing part 3211 is located to the carrier 200, so that when the fixing part 3211 is fixedly connected to the first side wall 110 of the outer frame 100, the elastic part 3212 is pressed against the side of the piezoelectric vibrator 312 facing away from the carrier 200, so as to generate a certain pre-pressing on the driving member 310. Moreover, the K value of the elastic part 3212 can be reduced to reduce the fluctuation of the pre-pressing of the elastic part 3212 on the driving member 310, thereby making the friction force between the friction head 311 and the carrier 200 more uniform and consistent.

In some optional embodiments, the pre-pressed part 320 may be implemented as an integrated structure, that is, the fixing part 3211 and the elastic part 3212 are integrally formed, and the bending part 3213 is formed by one-time stamping at the connection position of the fixing part 3211 and the elastic part 3212 to improve the consistency of the pre-pressing member 320. In some optional embodiments, the pre-pressing member 320 may also be implemented as a split structure, that is, the fixing part 3211, the elastic part 3212 and the bending part 3213 are manufactured separately and then connected together by bonding or welding to simplify the manufacture of the pre-pressing member 320.

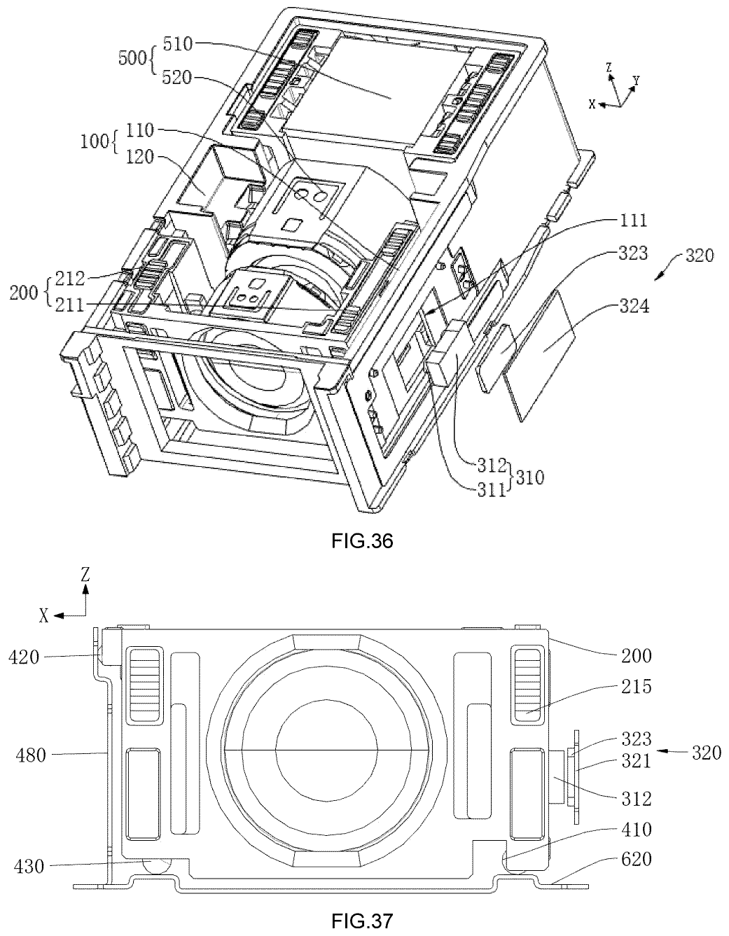

In some optional embodiments, the pre-pressing member 320 may be implemented as comprising a buffer member 323 and a structural member 324. As shown in FIG. 36, the structural member 324 is connected to the first side wall 110 of the outer frame 100, and the buffer member 323 is fixed to the first side wall 110 of the outer frame 100. One side of the buffer member 323 is connected to the driving member 310, that is, the buffer member 323 is installed on the first side wall 110 of the outer frame 100 through the structural member 324, and the buffer member 323 is arranged on the driving member 310. The driving member 310 is disposed between the first side wall 110 of the outer frame 100, or between the driving member 310 and the structural member 324, and is suitable for being deformed by being squeezed by the first side wall 110 of the outer frame 100 and the driving member 310, and is used to apply pre-pressing to the driving member 310 so that the friction head 311 of the driving member 310 abuts against the first carrier side wall 211 of the carrier 200, so that the driving member 310 is suitable for driving the carrier 200 to move with respect to the outer frame 100 when receiving a driving signal.

The first side wall 110 of the outer frame 100 is provided with an opening that passes through the first side wall 110 which is used to install the pre-pressing actuator assembly 300, the structural member 324 is arranged on the side of the opening facing outward, and the size of the structural member 324 is not smaller than the opening, one side of the buffer member 323 is connected to the side of the first side wall 110 of the outer frame 100, and the other side of the buffer member 323 is connected to the piezoelectric vibrator 312 of the driving member 310, that is, the buffer member 323 is connected to the first side wall 110 of the outer frame 100 and the piezoelectric vibrator 312 of the driving member 310 on both sides by attaching.

More specifically, the buffer member 323 can be implemented as an adhesive tape, which does not need to be cured and can directly attach the driver 310 to the structural member 324, and the adhesive tape also has a high degree of flatness, so that the piezoelectric vibrator 312 of the driver 310 directly attached to the structural member 324 through the buffer member 323 has a good parallelism with respect to the structural member 324. In this way, the use of high elastic modulus glue is also avoided. For example, when UV glue is used for bonding, the elastic modulus of the UV glue is relatively large after curing, and it is not suitable to be set between the structural member 324 and the driving member 310.

It is worth mentioning that the size of the buffer member 323 can be smaller than, equal to or larger than the size of the piezoelectric vibrator 312 of the driving member 310. In one example, the size of the buffer member 323 is equal to or larger than the size of the piezoelectric vibrator 312 of the driving member 310. Thus, the space between the piezoelectric vibrator 312 of the driving member 310 and the structural member 324 can be completely filled by the buffer member 323, which is beneficial to ensure the parallelism of the piezoelectric vibrator 312 of the driving member 310 with respect to the structural member 324.

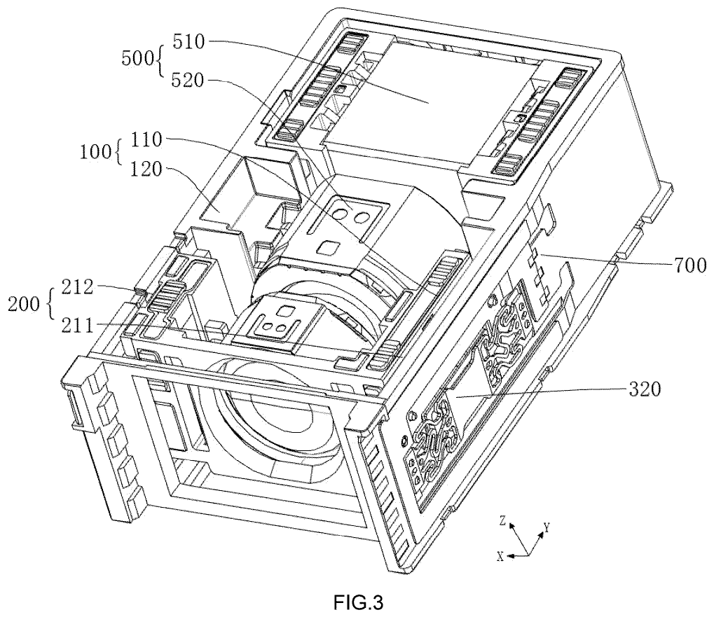

It can be understood that the buffer member 323 can be arranged between the resilient piece 321 and the piezoelectric vibrator 312. As shown in FIGS. 3 and 4, the two sides of the buffer member 323 are attached to the side of the resilient piece 321 and the side of the piezoelectric vibrator 312 to connect the two without significantly increasing the overall thickness of the pre-pressing actuator assembly 300.

The above describes the basic principles, main features and advantages of the present application. Those skilled in the art should understand that the present application is not limited by the above embodiments, and the above embodiments and the specification only describe the principles of the present application. The present application may have various changes and improvements without departing from the spirit and scope of the present application, and these changes and improvements fall within the scope of the present application for which protection is sought. The scope of protection claimed by the present application is defined by the attached claims and their equivalents.

What is claimed is:

1. A periscope camera module, comprising:
an outer frame;
a carrier capable of moving at an inner side of the outer frame along an optical axis direction, wherein the carrier is arranged for carrying at least one lens piece;
a pre-pressing actuator assembly which is disposed on a side wall of the carrier and applies a pre-pressing force to the carrier along a direction perpendicular to the optical axis direction, so as to drive the carrier to move along the optical axis direction; and
a support assembly assembled between the outer frame and the carrier, the support assembly comprises a first support part and a second support part;
wherein the first support part and the second support part are respectively arranged on two opposite sides of the carrier, the first support part is arranged on one side of the carrier in contact with the pre-pressing actuator assembly, and the first support part is tightly fitted between a bottom of the outer frame and a bottom of the carrier, and the second support part is arranged on an other side of the carrier not in contact with the pre-pressing actuator assembly and is loosely fitted between the outer frame and the carrier;
wherein the pre-compressing actuator assembly comprises:
a pre-pressing member which is assembled on the side wall of the outer frame;
a driving member which is assembled between the pre-pressing member and the side wall of the carrier;
wherein the pre-pressing member applies the pre-pressing force to the driving member toward the carrier along a direction perpendicular to the side wall of the carrier, so as to maintain frictional contact between the driving member and the side wall of the carrier.

2. The periscope camera module according to claim 1, wherein the second support part is disposed between a top of the outer frame and a top of the carrier.

3. The periscope camera module according to claim 1, wherein in a state in which the pre-pressing actuator assembly is not energized, a straight-line distance between the second support part and the pre-pressing actuator assembly is not less than a straight-line distance between the first support part and the pre-pressing actuator assembly.

4. The periscope camera module according to claim 1, wherein each of the first support part and the second support part comprise two ball bearings arranged in parallel to the optical axis direction, and a size of the ball bearings of the first support part is not smaller than a size of the ball bearings of the second support part.

5. The periscope camera module according to claim 1, wherein the support assembly further comprises a third support part assembled between the outer frame and the carrier; wherein the first support part and the third support part are oppositely disposed at two sides of the bottom of the carrier.

6. The periscope camera module according to claim 5, wherein each of the first support part, the second support part, and the third support part comprises a guide rod or two ball bearings arranged in parallel to the optical axis direction.

7. The periscope camera module according to claim 1, further comprising a magnetic attracting assembly oppositely disposed on the outer frame and the carrier and extending in parallel to the optical axis direction for applying a magnetic attracting force to the carrier along a direction perpendicular to the optical axis direction but not parallel to the direction of the pre-pressing force.

8. The periscope camera module according to claim 1, wherein the driving member comprises a friction head frictionally connected with the sidewall of the carrier, wherein the friction head is in frictional contact with the sidewall of the carrier.

9. The periscope camera module according to claim 8, wherein the driving member further comprises a piezoelectric vibrator disposed between the pre-pressing member and the friction head, a length direction of the piezoelectric vibrator is parallel to the optical axis direction, wherein the piezoelectric vibrator is arranged for vibrating or piezoelectrically actuating the friction head to generate a driving force for moving the carrier.

10. The periscope camera module according to claim 8, wherein the pre-pressing member is a resilient piece extended in parallel to the optical axis direction and comprising a fixing part for fixing the pre-pressing member on the sidewall of the outer frame, and for applying the pre-pressing force toward the carrier along the direction perpendicular to the sidewall of the carrier.
